(19) United States
(12) Patent Application Publication
(10) Pub. No.: US 2017/0336728 A1
(43) Pub. Date: Nov. 23, 2017

(54) ULTRAVIOLET CURABLE LIQUID COMPOSITION, ULTRAVIOLET CURING INKJET INK, ULTRAVIOLET CURING WET ELECTROPHOTOGRAPHIC LIQUID DEVELOPER, ULTRAVIOLET CURING ELECTROSTATIC INKJET INK, AND IMAGE FORMING METHOD USING THEREOF

(71) Applicant: CANON KABUSHIKI KAISHA, Tokyo (JP)

(72) Inventors: Junji Ito, Hiratsuka-shi (JP); Naotake Sato, Sagamihara-shi (JP); Yasuhiro Aichi, Tokyo (JP)

(73) Assignee: CANON KABUSHIKI KAISHA, Tokyo (JP)

(21) Appl. No.: 15/533,808

(22) PCT Filed: Jan. 7, 2016
(86) PCT No.: PCT/JP2016/051058

§ 371 Date: Jun. 7, 2017

(30) Foreign Application Priority Data
Jan. 9, 2015 (JP) 2015-003347
Dec. 28, 2015 (JP) 2015-257003

(51) Int. Cl. G03G 9/125; C09D 11/322; C09D 11/106; C09D 11/101; C08F 216/16; C09D 11/38; C08F 216/12

(52) U.S. Cl. CPC G03G 9/125; C09D 11/38; C09D 11/322; C08F 216/125; C09D 11/101; C08F 216/165; C09D 11/106

(57) ABSTRACT

An object of the present invention is to provide an ultraviolet curing liquid composition having high sensitivity, excellent storage stability, low viscosity, and excellent fixability after ultraviolet curing. The ultraviolet curable liquid composition of the present invention is an ultraviolet curable liquid composition containing a cationically polymerizable liquid monomer, a photopolymerization initiator and a photopolymerization sensitizer, wherein the cationically polymerizable liquid monomer is a vinyl ether compound, the photopolymerization initiator includes a compound represented by general formula (1), and the photopolymerization sensitizer includes (A) at least one compound selected from the group consisting of a compound represented by general formula (2) and a compound represented by general formula (3), and (B) at least one compound selected from the group consisting of a compound represented by general formula (4) and a compound represented by general formula (5).

### TECHNICAL FIELD

The present invention relates to an ultraviolet curing wet electrophotographic liquid developer that can be used in an image forming apparatus utilizing an electrophotographic system such as an electrophotographic method, an electrostatic recording method or electrostatic printing and an ultraviolet curable liquid composition that can be used as an ultraviolet curing inkjet ink and an ultraviolet curing electrostatic inkjet ink. In the other embodiment, the present invention also relates to an image forming method by using of the ultraviolet curable liquid composition, the ultraviolet curing inkjet ink, the ultraviolet curable liquid composition, and the ultraviolet curing electrostatic inkjet ink.

### BACKGROUND ART

Conventionally, a printing machine utilizing a printing plate has been used for producing printed products required to be provided in a certain number, such as local advertisings, documents distributed in company, and large posters.

In recent years, an on-demand printing machine capable of rapidly responding to diversified needs and also allowing stock to be reduced has been increasingly utilized instead of such a conventional printing machine. As such an on-demand printing machine, an electrophotographic printing machine using a liquid developer and an inkjet printer capable of high-speed and high-image quality printing have been expected. The liquid developer, in which an electrically insulating liquid is used as a carrier liquid, thus hardly causes the problem of aggregation of a coloring resin particle in the liquid developer during storage, as compared with a dry developer, and a fine toner can be used therein. As a result, the liquid developer has the following characteristics: reproducibility of a fine line image is good, gradation reproducibility is good, color reproducibility is excellent, and availability in a high-speed image forming method is excellent, as compared with a dry developer. A high-image quality and high-speed digital printing apparatus that utilizes such excellent characteristics and that utilizes an electrophotographic technique using the liquid developer is increasingly actively developed.

In view of such circumstances, a liquid developer having better properties is demanded to be developed. As the liquid developer, a photocuring liquid developer is known. The photocuring liquid developer can be prepared by using a monomer or oligomer having a reactive functional group as an electrically insulating liquid, and further adding and dissolving a photopolymerization initiator. The photocuring liquid developer can be cured by a polymerization reaction due to irradiation with light such as ultraviolet ray, and thus address a high-speed developing treatment. As the polymerization type for such photocuring, a radical polymerization type and a cationic polymerization type are widely known. As a photopolymerization initiator to be contained in a cationic polymerization type photocuring liquid developer, an ionic photo-acid generator is known as described in Examples in PTL 1 and in NPL 1.

On the other hand, various inks such as a water-based ink, a solvent-based type ink and an ultraviolet curing ink are used in an inkjet printer.

As a technique for reductions in thermal energy to be consumed and the amount of a volatile organic solvent vapor to be diffused, an electrostatic inkjet system is known. The electrostatic inkjet system is a system which an ink including a charged particle dispersed in an electrically insulating liquid is used and the charged particle is electrophoresed by application of an electrostatic field, and concentrated and ejected. The ultraviolet curing ink includes an ultraviolet curable liquid, and a colorant such as a dye and a pigment. Also as the ultraviolet curing ink, a radical polymerization type ink and a cationic polymerization type ink are widely known.

PTL 2 describes the following: a combination of a plurality of vinyl ether compounds as ultraviolet curable liquid components allow a cationic polymerization type ultraviolet curing ink to obtain a high sensitivity and enhanced adhesiveness to a recording medium.

Cited Literature 3 discloses the following: a cationic polymerization type ink has the problem of insufficient storage stability due to a reaction based on an acid generated over time, and the instability is a large obstacle to practical use. PTL 3 describes an active radiation-curing inkjet ink composition to which a basic compound including a tertiary hindered amine structure in the molecule is added in order to suppress deterioration in storage stability due to generation of the acid. Such a technique is an attempt where the basic compound including a photodecomposable tertiary hindered amine structure is contained in the ink and the compound is decomposed during exposure to allow storage stability of the ink during storage and sensitivity thereof during exposure to be simultaneously satisfied.

PTL 4 describes use of a thioxanthone derivative and a naphthalene derivative as a sensitizer for a cationically polymerizable composition to thereby allow an excellent sensitization effect to be exerted. PTL 5 describes a cationic polymerization type ultraviolet curable composition in which an ionic aromatic onium salt is used as a photopolymerization initiator, and an anthracene derivative and a naphthalene derivative or a benzene derivative are used in combination as a photopolymerization sensitizer composition.

### CITATION LIST

### Patent Literatures

PTL 1: Japanese Patent No. 3442406

PTL 2: Japanese Patent Application Laid-Open No. 2005-154734

PTL 3: Japanese Patent Application Laid-Open No. 2009-84448

PTL 4: Japanese Patent Application Laid-Open No. 2007-126612

PTL 5: Japanese Patent Application Laid-Open No. 2011-246606

### Non-Patent Literature

NPL 1: Koji ARIMITSU, Fine Chemical Vo. 139 (No.2) P36 (2010)

### SUMMARY OF INVENTION

### Technical Problem

In a radical polymerization type photocurable liquid developer including a liquid acrylic monomer or oligomer, volume resistivity is easily reduced and the potential of an electrostatic latent image in a developing step is easily dropped. Therefore, a high optical density may be difficult to achieve in the developing step, and image blurring may be caused. In addition, a radical polymerization type photocuring liquid developer including an acrylic monomer may be inhibited by oxygen from being cured, and is required to be used in combination with an acrylic monomer or oligomer having a relatively high molecular weight. As a result, the viscosity of the liquid developer may be increased to result in a reduction in the electrophoretic velocity of a toner charged, namely, a reduction in the rate of production in image formation.

On the contrary, cationic polymerization is a polymerization system less affected by oxygen and suitable for a photocuring liquid developer. In particular, a vinyl ether monomer can be used as an electrically insulating liquid to thereby easily provide a liquid developer having a high volume resistivity, increasing the reaction rate in a photocuring reaction and also facilitating a reduction in the viscosity of the liquid developer. Therefore, the vinyl ether monomer is suitable as an electrically insulating liquid for use in a photocuring liquid developer by cationic polymerization.

As a photoinitiator for use in such cationic polymerization, an ionic photo-acid generator is generally used.

The ionic photo-acid generator, however, may cause the volume resistivity of the liquid developer to be significantly reduced, and thus the potential of an electrostatic latent image in a developing step may be easily dropped, a high optical density may be difficult to achieve in the developing step, or image blurring may be caused.

The increase in viscosity of the ink described above, which is problematic in the radical polymerization type photocuring liquid developer, is again problematic in an inkjet photocuring ink in terms of a reduction in ink ejection performance, and a cationic polymerization type photocuring ink that can address a reduction in viscosity of the ink is suitable.

As described above, however, PTL 3 describes the following: the cationic polymerization type ink has the problem of being not sufficient in stability during storage due to a reaction based on an acid generated over time, and has a large obstacle to practical use. Then, in PTL 3, the basic compound including a tertiary hindered amine structure in the molecule is added to the active radiation-curing inkjet ink composition for the purpose of suppressing the action of an acid generated during storage. Such a technique is an attempt where the basic compound including a photodecomposable tertiary hindered amine structure is decomposed during exposure to allow storage stability of the ink during storage and sensitivity thereof during exposure to be simultaneously satisfied.

Meanwhile, the rates of an acid release reaction from a photopolymerization initiator during exposure and a subsequent polymerization reaction of vinyl ether are very high, and therefore it is very difficult to complete photodecomposition of a photodecomposable basic compound before initiation of the polymerization reaction in exposure.

Accordingly, storage stability of the cationic polymerization type ultraviolet curing ink and sensitivity thereof with respect to photocurability are not sufficiently satisfied simultaneously. Such storage stability and sensitivity with respect to photocurability, not sufficiently satisfied simultaneously, are also technically problematic again in the liquid developer described above.

The aromatic onium salt is used as a photopolymerization initiator in both of PTL 4 and PTL 5, but the aromatic onium salt cannot be applied to the liquid developer or the electrostatic inkjet ink because of significantly reducing the volume resistivity of the ultraviolet curable liquid even when added in a trace amount. In addition, no descriptions about storage stability and sensitivity satisfied simultaneously are made at all in both of PTL 4 and PTL 5.

An object of the present invention is to provide an ultraviolet curing liquid composition having high sensitivity, excellent storage stability, low viscosity, and excellent fixability after ultraviolet curing, as well as a liquid developer and an inkjet ink using the ultraviolet curing liquid composition. Solution to Problem

The ultraviolet curable liquid composition of the present invention is an ultraviolet curable liquid composition containing a cationically polymerizable liquid monomer, a photopolymerization initiator and a photopolymerization sensitizer, wherein the cationically polymerizable liquid monomer is a vinyl ether compound, the photopolymerization initiator includes a compound represented by the following general formula (1), and the photopolymerization sensitizer includes (A) at least one compound selected from the group consisting of a compound represented by the following general formula (2) and a compound represented by the following general formula (3), and (B) at least one compound selected from the group consisting of a compound represented by the following general formula (4) and a compound represented by the following general formula (5).

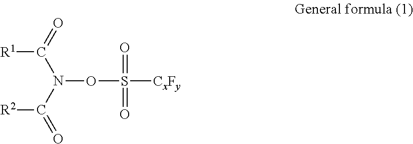

In the general formula (1), x represents an integer of 1 to 8, y represents an integer of 3 to 17, and R¹ and R² are bound to each other to form a cyclic structure.

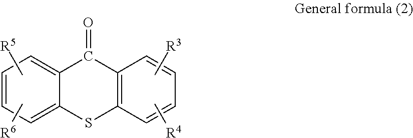

In the general formula (2), R³, R⁴, R⁵ and R⁶ each independently represent a hydrogen atom, a substituted or unsubstituted alkyl group, a substituted or unsubstituted cycloalkyl group, a substituted or unsubstituted alkoxy group, a substituted or unsubstituted aryloxy group, a cyano group, a substituted or unsubstituted aralkyl group, a substituted or unsubstituted alkoxycarbonyl group, or a halogen atom.

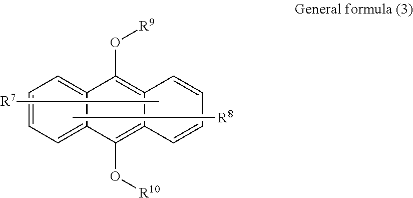

In the general formula (3), R⁷ and R⁸ each independently represent a hydrogen atom, an alkyl group, an aralkyl group, an alkoxy group, an aryloxy group or a halogen atom, and R⁹ and R¹⁰ each independently represent a hydrogen atom, an alkyl group having 1 to 9 carbon atoms optionally substituted with a substituent having an oxygen atom, or a glycidyl group.

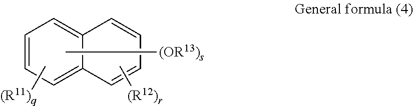

In the general formula (4), R¹¹ and R¹² each independently represent an alkyl group, an aralkyl group, an alkoxy group, an aryloxy group or a halogen atom, q and r each independently represent an integer of 0 to 4, R¹³ represents a hydrogen atom, an alkyl group having 1 to 9 carbon atoms optionally substituted with a substituent having an oxygen atom, or a glycidyl group, s represents an integer of 1 to 3, each R¹¹ is independently defined as above when a plurality of R¹¹(s) are present, each R¹² is independently defined as above when a plurality of R¹²(s) are present, and each R¹³ is independently defined as above when a plurality of R¹³(s) are present.

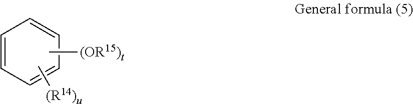

In the general formula (5), R¹⁴ represents an alkyl group, an aralkyl group, an alkoxy group, an aryloxy group or a halogen atom, u represents an integer of 0 to 4, R¹⁵ represents a hydrogen atom, an alkyl group having 1 to 9 carbon atoms optionally substituted with a substituent having an oxygen atom, or a glycidyl group, t represents an integer of 1 or 2, each R¹⁴ is independently defined as above when a plurality of R¹⁴(s) are present, and each R¹⁵ is independently defined as above when a plurality of R¹⁵(s) are present.

In addition, the image forming method of the present invention is an image forming method to fix an image formed on a recording medium with the ultraviolet curable liquid composition and a colorant to the recording medium by an ultraviolet light irradiation.

### Advantageous Effects of Invention

According to the present invention, a vinyl ether compound can be combined with the combination of the specific compounds as the photopolymerization initiator and the photopolymerization sensitizer, thereby providing an ultraviolet curing liquid composition having high sensitivity, excellent storage stability, low viscosity, and excellent fixability after ultraviolet curing.

Further features of the present invention will become apparent from the following description of exemplary embodiments.

### DESCRIPTION OF EMBODIMENTS

Hereinafter, the present invention is described in detail.

The ultraviolet curable liquid composition of the present invention includes the following components:
At least one vinyl ether compound as a cationically polymerizable liquid monomer;
At least one compound represented by the general formula (1) as a photopolymerization initiator;
At least one compound selected from the group consisting of a compound represented by the general formula (2) and a compound represented by the general formula (3), and at least one compound selected from the group consisting of a compound represented by the general formula (4) and a compound represented by the general formula (5), as a photopolymerization sensitizer.

[Ultraviolet Curable Liquid Composition]

The ultraviolet curable liquid composition of the present invention contains a photopolymerization initiator, a photopolymerization sensitizer and a vinyl ether compound as a cationically polymerizable liquid monomer.

Hereinafter, the respective constitutive components contained in the ultraviolet curable liquid composition of the present invention are sequentially described.

[Photopolymerization Initiator]

The photopolymerization initiator in the present invention is represented by the following general formula (1).

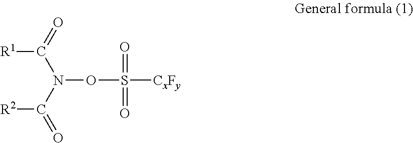

In the general formula (1), x represents an integer of 1 to 8, y represents an integer of 3 to 17, and R¹ and R² are bound to each other to form a cyclic structure in which the cyclic backbone is partially formed from an imide structure. The photopolymerization initiator represented by the general formula (1) can be contained to thereby provide an ultraviolet curable liquid composition that is high in resistivity unlike an ionic photo-acid generator while having sufficient fixability, and can be combined with a photopolymerization sensitizer described later to thereby realize an excellent storage stability.

The photopolymerization initiator in the present invention is photo-decomposed by irradiation with ultraviolet ray to generate sulfonic acid that is a strong acid. In addition, the photopolymerization initiator is used in combination with a photopolymerization sensitizer described later, and absorption of ultraviolet ray by the sensitizer serves as a trigger to allow decomposition of the initiator and generation of sulfonic acid to be performed. CₓF_{y} having a large electron withdrawing property is an essential functional group for decomposing a sulfonic acid ester moiety by irradiation with ultraviolet ray, and the number of carbon atoms is 1 to 8 (x=1 to 8) and the number of fluorine atoms is 3 to 17 (y=3 to 17).

When the number of carbon atoms is 1 or more, a strong acid is easily synthesized, and when the number of carbon atoms is 8 or less, storage stability is excellent. When the number of fluorine atoms is 3 or more, the action as a strong acid is enabled, and when the number of fluorine atoms is 17 or less, a strong acid is easily synthesized.
CₓF_{y} in the general formula (1) can be CF₃, C₂F₅, C₃F₇, C₄F₉ or C₆F₅.

Examples of CₓF_{y} in the general formula (1) include the following respective groups.
A linear alkyl group in which at least one hydrogen atom is substituted with a fluorine atom (RF1 group)
A branched alkyl group in which at least one hydrogen atom is substituted with a fluorine atom (RF2 group)
A cycloalkyl group in which at least one hydrogen atom is substituted with a fluorine atom (RF3 group)
An aryl group in which at least one hydrogen atom is substituted with a fluorine atom (RF4 group)

As the RF1 group, one in which all hydrogen atoms are not substituted with fluorine can be utilized, but one in which all hydrogen atoms are substituted with fluorine can be adopted. Examples include a trifluoromethyl group (x=1, y=3), a pentafluoroethyl group (x=2, y=5), a nonafluorobutyl group (x=4, y=9), a perfluorohexyl group (x=6, y=13) and a perfluorooctyl group (x=8, y=17).

As the RF2 group, one in which all hydrogen atoms are not substituted with fluorine can be utilized, but one in which all hydrogen atoms are substituted with fluorine can be adopted. Examples include a perfluoroisopropyl group (x=3, y=7), a perfluoro-tert-butyl group (x=4, y=9) and a perfluoro-2-ethylhexyl group (x=8, y=17).

As the RF3 group, one in which all hydrogen atoms are not substituted with fluorine can be utilized, but one in which all hydrogen atoms are substituted with fluorine can be adopted. Examples include a perfluorocyclobutyl group (x=4, y=7), a perfluorocyclopentyl group (x=5, y=9), a perfluorocyclohexyl group (x=6, y=11) and a perfluoro (1-cyclohexyl)methyl group (x=7, y=13).

As the RF4 group, one in which all hydrogen atoms are not substituted with fluorine can be utilized, but one in which all hydrogen atoms are substituted with fluorine can be adopted. Examples include a pentafluorophenyl group (x=6, y=5) and a 3-trifluoromethyltetrafluorophenyl group (x=7, y=7).

As CₓF_{y} in the general formula (1), the RF1 group, the RF2 group and the RF4 group are preferable, and the RF1 group and the RF4 group are further preferable in terms of availability and a decomposition property of the sulfonic acid ester moiety. A trifluoromethyl group (x=1, y=3), a pentafluoroethyl group (x=2, y=5), a heptafluoropropyl group (x=3, y=7), a nonafluorobutyl group (x=4, y=9) and a pentafluorophenyl group (x=6, y=5) are particularly preferable.

The cyclic structure included in the photopolymerization initiator that can be used in the present invention, in which the cyclic backbone is partially formed from an imide structure, can be selected from the group consisting of structures utilized for absorption of ultraviolet ray among a nitrogen-containing monocyclic structure, a nitrogen-containing bicyclic structure, a nitrogen-containing tricyclic structure and a nitrogen-containing tetracyclic structure each having a cyclic imide structure. The cyclic structure selected, in which the cyclic backbone is partially formed from an imide structure, can be utilized in combination with various moieties for sulfonic acid release. As such a cyclic structure, a cyclic structure included in a compound described later can be adopted, and can be used in combination with a sulfonic acid release moiety represented as CₓF_{y} in the general formula (1).

Examples of the cyclic structure having an imide structure forming a light absorption moiety in the compound represented by the general formula (1) include the following respective groups.

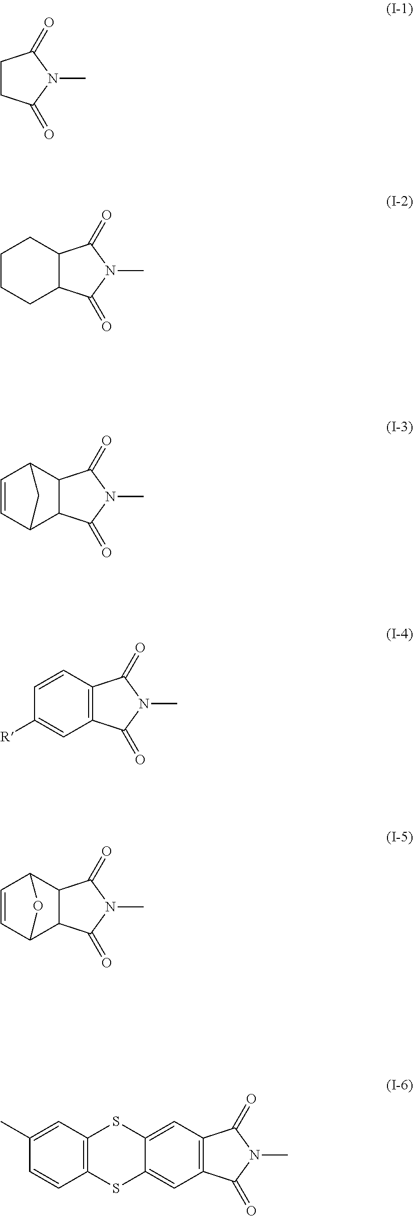

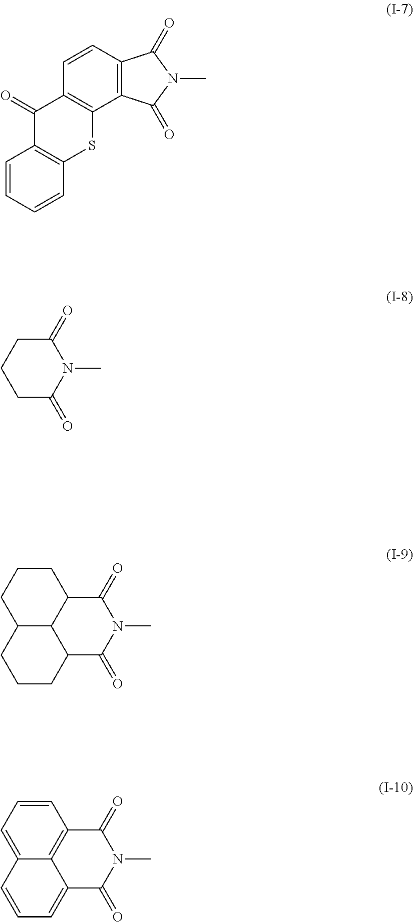

R′ in the formula (1-4) can be selected from the group consisting of a hydrogen atom, an alkylthio group having 1 to 6 carbon atoms, such as C₄H₉-S-, or an arylthio group having any structure represented below.

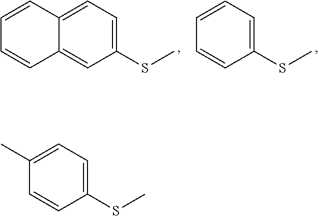

Specific examples [exemplary compounds A-1 to A-27] of the photopolymerization initiator that can be used in the present invention include the following, but the photopolymerization initiator is not limited to such specific examples in the present invention.

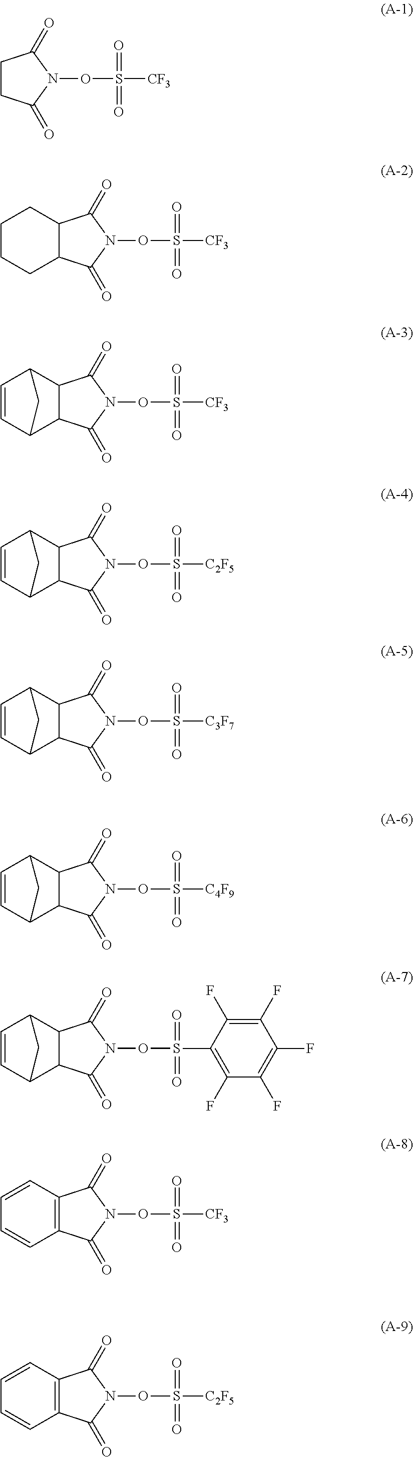

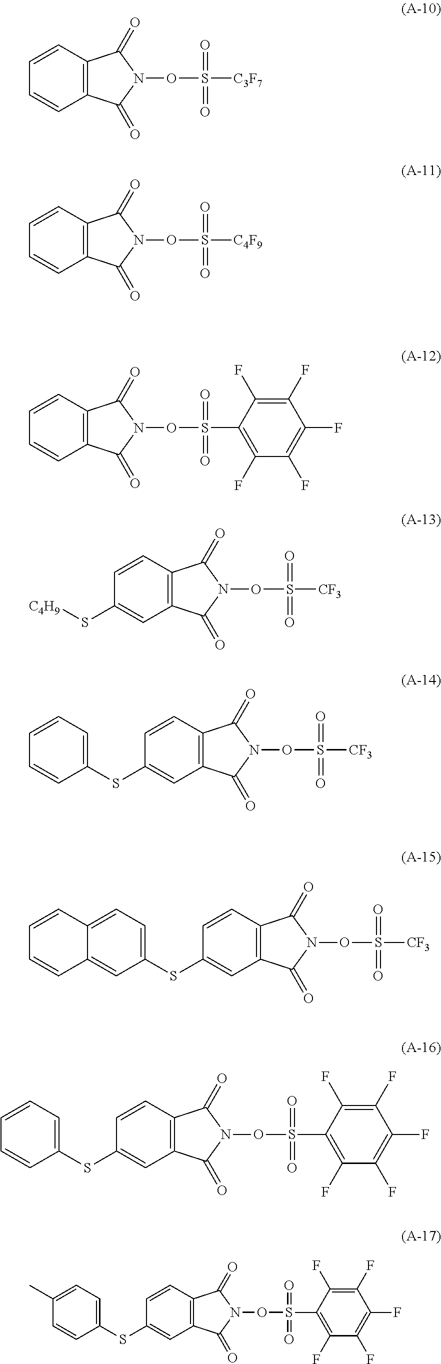

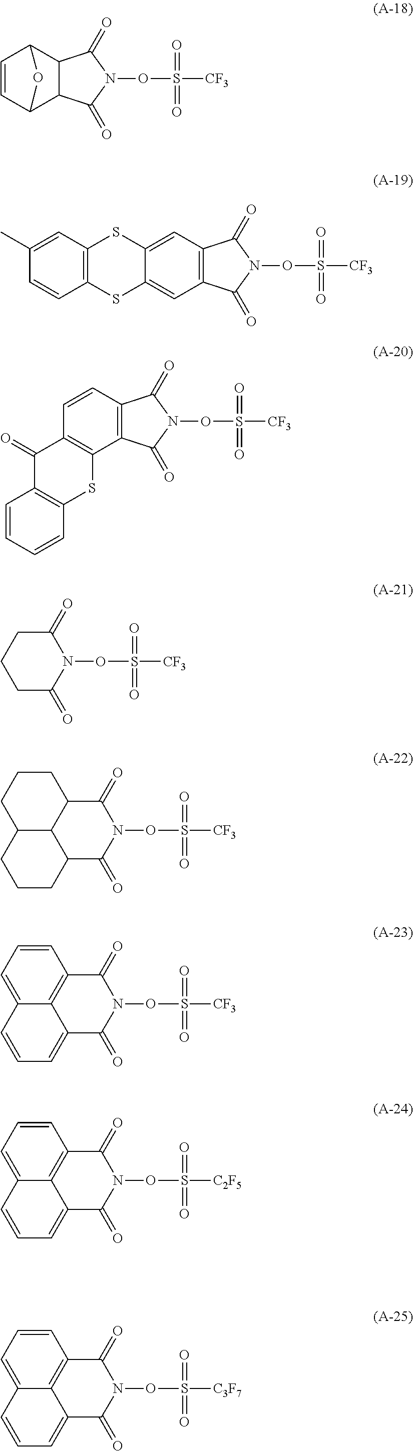

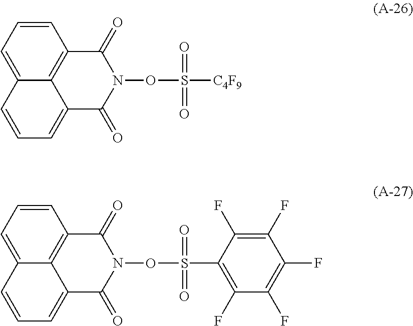

The photopolymerization initiator can be used singly or in combinations of two or more. The content of the photopolymerization initiator in the ultraviolet curable liquid composition of the present invention is not particularly limited, and is preferably 0.01 to 5 parts by mass, more preferably 0.05 to 1 part by mass, further preferably 0.1 to 0.5 parts by mass based on 100 parts by mass of the cationically polymerizable liquid monomer. If two or more compounds represented by the general formula (1) are combined, the content of the photopolymerization initiator is the total content of such compounds.

[Photopolymerization Sensitizer]

Next, the photopolymerization sensitizer for use in the present invention is described.

In general, a photopolymerization sensitizer is often used in combination with a photopolymerization initiator for the purposes of an enhancement in acid generation efficiency of a photo-acid generator and an increase in photosensitive wavelength. In the present invention, the photopolymerization initiator represented by the general formula (1) can be used in combination with the vinyl ether compound as the cationically polymerizable liquid monomer, and at least one compound selected from the group consisting of the compound represented by the general formula (2) and the compound represented by the general formula (3), and at least one compound selected from the group consisting of the compound represented by the general formula (4) and the compound represented by the general formula (5), as the photopolymerization sensitizer, thereby also imparting an excellent storage stability.

The compound represented by the general formula (2) is described.

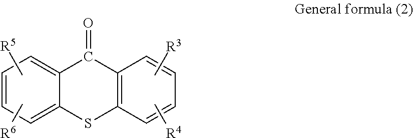

In the general formula (2), R³, R⁴, R⁵ and R⁶ each independently represent a hydrogen atom, a substituted or unsubstituted alkyl group, a substituted or unsubstituted cycloalkyl group, a substituted or unsubstituted alkoxy group, a substituted or unsubstituted aryloxy group, a cyano group, a substituted or unsubstituted aralkyl group, a substituted or unsubstituted alkoxycarbonyl group, or a halogen atom.

In the general formula (2), examples of the unsubstituted alkyl group include linear or branched alkyl groups having 1 to 4 carbon atoms, such as a methyl group, an ethyl group, an n-propyl group, an i-propyl group, an n-butyl group, an i-butyl group and a t-butyl group. Examples of the unsubstituted cycloalkyl group include a cyclohexyl group. Examples of the unsubstituted alkoxy group include linear or branched alkylalkoxy groups having 1 to 4 carbon atoms, such as a methoxy group, an ethoxy group, an n-propoxy group, an i-propoxy group, an n-butoxy group, an i-butoxy group and a t-butoxy group. Examples of the unsubstituted aryloxy group include a phenoxy group. Examples of the unsubstituted alkoxycarbonyl group include a methoxycarbonyl group and an ethoxycarbonyl group.

Examples of the aralkyl group include a benzyl group.

Examples of the halogen atom include a chlorine atom, a bromine atom and an iodine atom.

The substituent included in each of the substituted alkyl group, the substituted cycloalkyl group, the substituted alkoxy group, the substituted aryloxy group, the substituted aralkyl group and the substituted alkoxycarbonyl group may be any substituent that can allow the compound represented by the general formula (2) to function as the intended photopolymerization sensitizer. Examples of the substituent can include substituents such as an alkyloxy group having 1 to 4 carbon atoms, a phenyl group and a morpholino group. In addition, as the substituted alkoxycarbonyl group, a group in which a carboxyl group is esterified by polyethylene glycol can also be utilized.

Examples of the compound represented by the general formula (2) include the following compounds, for example, thioxanthone, 2-isopropylthioxanthone, 2-dodecylthioxanthone, 2-cyclohexylthioxanthone, 2,4-diethylthioxanthone, 2,4-dimethylthioxanthone, 1-phenoxythioxanthone, 1-methoxycarbonylthioxanthone, 2-ethoxycarbonylthioxanthone 3-(2-methoxyethoxycarbonyl)-thioxanthone, 4-butoxycarbonylthioxanthone, 3-butoxycarbonyl-7-methylthioxanthone, 3,4-di-[2-(2-methoxyethoxy)-ethoxycarbonyl]-thioxanthone, 2-chlorothioxanthone, 1-ethoxycarbonyl-3-ethoxythioxanthone, 1-ethoxycarbonyl-3-chlorothioxanthone, 1-chloro-4-n-propoxythioxanthone, 2-methyl-6-dimethoxymethyl-thioxanthone, 2-methyl-6-(1,1-dimethoxybenzyl)-thioxanthone, 6-ethoxycarbonyl-2-methoxy-thioxanthone, 6-ethoxycarbonyl-2-methylthioxanthone, 1-ethoxycarbonyl-3-(1-methyl-1-morpholinoethyl)-thioxanthone, 2-morpholinomethylthioxanthone, 2-methyl-6-morpholinomethylthioxanthone, thioxanthone-2-carboxylic acid polyethylene glycol ester, 1-cyano-3-chlorothioxanthone and 1-ethoxycarbonyl-3-phenylsulfurylthioxanthone.

In particular, 2-isopropylthioxanthone, 2-cyclohexylthioxanthone, 2,4-diethylthioxanthone, 2-chlorothioxanthone or 1-chloro-4-n-propoxythioxanthone can be adopted because of being easily synthesized, having a high sensitization effect of the ultraviolet curable liquid composition, and exerting an excellent sensitization effect when used in combination with the compound represented by the general formula (4) or the compound represented by the general formula (5). The compound represented by the general formula (3) is described.

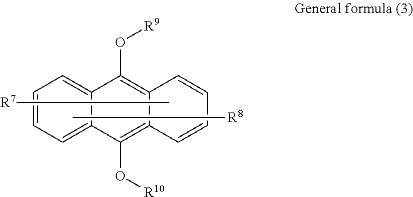

In the general formula (3), R⁷ and R⁸ each independently represent a hydrogen atom, an alkyl group, an aralkyl group, an alkoxy group, an aryloxy group or a halogen atom, and R⁹ and R¹⁰ each independently represent a hydrogen atom, an aralkyl group, an alkyl group having 1 to 9 carbon atoms optionally substituted with an oxygen atom, or a glycidyl group.

In the general formula (3), examples of the alkyl group in each of R⁷ and R⁸ include linear or branched alkyl groups having 1 to 4 carbon atoms, such as a methyl group, an ethyl group and a t-butyl group. Examples of the aralkyl group include a benzyl group and a phenethyl group. Examples of the alkoxy group include a methoxy group and an ethoxy group. Examples of the aryloxy group include a phenoxy group.

Examples of the aralkyl group include a benzyl group.

Examples of the halogen atom include a chlorine atom, a bromine atom and an iodine atom.

In the general formula (3), examples of the alkyl group having 1 or more and 9 or less carbon atoms optionally substituted with a substituent having an oxygen atom, in R⁹ and R¹⁰ include a linear or branched alkyl group in which at least one hydrogen atom may be substituted with a substituent having an oxygen atom. Examples of the substituent having an oxygen atom include a hydroxy group, alkyloxy groups having 1 to 8 carbon atoms, such as a methoxy group and an ethoxy group, and aryloxy groups such as a phenoxy group.

Examples of the alkyl group having 1 or more and 9 or less carbon atoms optionally substituted with the substituent having an oxygen atom, include a methyl group, an ethyl group, an n-propyl group, an i-propyl group, a n-butyl group, an i-butyl group, a n-pentyl group, an n-hexyl group, an n-heptyl group, an n-octyl group, a 2-ethylhexyl group, an n-nonyl group, a 2-hydroxyethyl group, a 3-hydroxyethyl group, a 2-hydroxypropyl group, a 2-methoxyethyl group, a 2-ethoxyethyl group and a 2-phenoxyethyl group. Examples of the glycidyl group include a glycidyl group and a 2-methylglycidyl group.

Examples of an anthracene-9,10-dioxy compound represented by the general formula (3) include the following compounds:
(1) 9,10-dimethoxyanthracene,
(2) 9,10-diethoxyanthracene,
(3) 9, 10-bis (n-propoxy) anthracene,
(4) 9, 10-bis (i-propoxy) anthracene,
(5) 9, 10-bis (n-butoxy) anthracene,
(6) 9, 10-bis (i-butoxy) anthracene,
(7) 9, 10-bis (n-pentyloxy) anthracene,
(8) 9, 10-bis (i-pentyloxy) anthracene,
(9) 9, 10-bis (n-hexyloxy) anthracene,
(10) 9,10-bis(n-heptyloxy)anthracene,
(11) 9,10-bis(n-octyloxy)anthracene,
(12) 9,10-bis(2-ethylhexyloxy)anthracene,
(13) 9,10-bis(n-nonyloxy)anthracene,
(14) 9,10-bis(2-methylglycidyloxy)anthracene,
(15) 9,10-dibenzyloxyanthracene,
(16) 9,10-diphenethyloxyanthracene and
(17) 9,10-diglycidyloxyanthracene.

In addition, examples of the anthracene-9,10-dioxy compound of the general formula (3), having an alkyl group as a substituent on the anthracene ring, include a compound in which the hydrogen atom at the 2-position of the anthracene ring in each of the compounds (1) to (17) described above is substituted with a linear or branched alkyl group having 1 to 4 carbon atoms, such as a methyl group, an ethyl group or a t-butyl group.

In addition, examples of the anthracene-9,10-dioxy compound of the general formula (3), having a halogen atom as a substituent on the anthracene ring, include a compound in which the hydrogen atom at the 2-position of the anthracene ring in each of the compounds (1) to (17) described above is substituted with a chlorine atom.

In addition, examples of the anthracene-9,10-dioxy compound of the general formula (3), having an alkoxy group as a substituent on the anthracene ring, include a compound in which the hydrogen atom at the 2-position of the anthracene ring in each of the compounds (1) to (17) described above is substituted with a methoxy group.

In addition, examples of the anthracene-9,10-dioxy compound of the general formula (3) having an aryloxy group as a substituent on the anthracene ring include a compound in which the hydrogen atom at the 2-position of the anthracene ring in each of the compounds (1) to (17) described above is substituted with a phenoxy group.

Among such anthracene compounds, in particular, 9,10-dimethoxyanthracene, 9,10-diethoxyanthracene, 9,10-bis(n-propoxy)anthracene, 9,10-bis(i-propoxy)anthracene, 9,10-bis(n-butoxy)anthracene or 9,10-bis(i-butoxy)anthracene can be adopted because of being easily synthesized, having a high sensitization effect of the ultraviolet curable liquid composition, and exerting an excellent sensitization effect when used in combination with the compound represented by the general formula (4) or the compound represented by the general formula (5).

In the present invention, the compound selected from the group consisting of the compound represented by the general formula (2) and the compound represented by the general formula (3) can be used singly or in combinations of two or more.

The total content of the compound selected from the group consisting of the compound represented by the compound represented by the general formula (2) and the compound represented by the general formula (3) in the entire ultraviolet curable liquid composition is defined as B% by mass, and the content of the compound represented by the general formula (1) in the entire ultraviolet curable liquid composition is defined as A % by mass. The B/A here is preferably 1.0 or more, further preferably 5.0 or more. When the compound selected from the group consisting of the compound represented by the general formula (2) and the compound represented by the general formula (3) is used in combination of two or more, the total content of two or more is defined as B% by mass. When the B/A is 1.0 or more, the amount of energy transfer from the compound selected from the group consisting of the compound represented by the general formula (2) and the compound represented by the general formula (3) to the photopolymerization initiator can be increased to result in a further enhancement in sensitivity.

The compound represented by the general formula (4) and the compound represented by the general formula (6) are described.

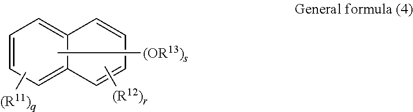

In the general formula (4), R¹¹ and R¹² each independently represent an alkyl group, an aralkyl group, an alkoxy group, an aryloxy group or a halogen atom, q and r each independently represent an integer of 0 to 4, R¹³ represents a hydrogen atom, an alkyl group having 1 to 9 carbon atoms optionally substituted with a substituent having an oxygen atom, a glycidyl group, or an aralkyl group, s represents an integer of 1 to 3, each R¹¹ is independently defined as above when a plurality of R¹¹(s) are present, each R¹² is independently defined as above when a plurality of R¹² (s) are present, and each R¹³ is independently defined as above when a plurality of R¹³(s) are present.

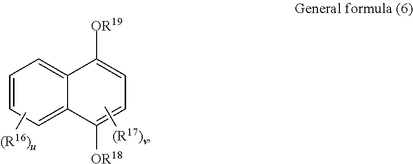

The compound represented by the general formula (4) can be the compound represented by the general formula (6).

In the general formula (6), R¹⁶ and R¹⁷ each independently represent an alkyl group, an aralkyl group, an alkoxy group, an aryloxy group or a halogen atom, u and v each independently represent an integer of 0 to 4, R¹⁸ and R¹⁹ each independently represent a hydrogen atom, an alkyl group having 1 to 9 carbon atoms optionally substituted with a substituent having an oxygen atom, a glycidyl group, or an aralkyl group, each R¹⁶ is independently defined as above when a plurality of R¹⁶(s) are present, and each R¹⁷ is independently defined as above when a plurality of R¹⁷(s) are present. In each of the general formulae (4) and (6), examples of the alkyl group having 1 or more and 9 or less carbon atoms optionally substituted with a substituent having an oxygen atom, represented by each of R¹³, R¹⁸ and R¹⁹ include a linear or branched alkyl group in which at least one hydrogen atom may be substituted with a substituent having an oxygen atom.

Examples of the substituent having an oxygen atom include a hydroxy group, alkyloxy groups having 1 to 8 carbon atoms, such as a methoxy group and an ethoxy group, and aryloxy groups such as a phenoxy group. Examples of the alkyl group having 1 or more and 9 or less carbon atoms optionally substituted with the substituent having an oxygen atom, include a methyl group, an ethyl group, an n-propyl group, an i-propyl group, an n-butyl group, an i-butyl group, an n-pentyl group, an n-hexyl group, an n-heptyl group, an n-octyl group, a 2-ethylhexyl group, an n-nonyl group, a 2-hydroxyethyl group, a 3-hydroxyethyl group, a 2-hydroxypropyl group, a 2-methoxyethyl group, a 2-ethoxyethyl group and a 2-phenoxyethyl group. Examples of the glycidyl group include a glycidyl group and a 2-methylglycidyl group.

In each of the general formulae (4) and (6), examples of the halogen atom in each of R¹¹, R¹², R¹⁶ and R¹⁷ include a fluorine atom, a chlorine atom and a bromine atom. Examples of the alkyl group include linear or branched alkyl groups having 1 to 4 carbon atoms, such as a methyl group, an ethyl group and a t-butyl group. Examples of the aralkyl group include a benzyl group and a phenethyl group. Examples of the alkoxy group include a methoxy group and an ethoxy group. Examples of the aryloxy group include a phenoxy group.

Examples of the aralkyl group include a benzyl group.

Examples of the halogen atom include a chlorine atom, a bromine atom and an iodine atom.

Examples of the naphthalene compound represented by the general formula (4) and the naphthalene compound represented by the general formula (6) include the following compounds (2-1) to (2-25):
(2-1) 1,4-dihydroxynaphthalene,
(2-2) 1,4-dimethoxynaphthalene,
(2-3) 1,4-diethoxynaphthalene,
(2-4) 1,4-bis(n-propoxy)naphthalene,
(2-5) 1,4-bis(i-propoxy)naphthalene,
(2-6) 1,4-bis(n-butoxy)naphthalene,
(2-7) 1,4-bis(i-butoxy)naphthalene,
(2-8) 1,4-bis(n-octyloxy)naphthalene,
(2-9) 1,4-bis(2-ethylhexyloxy)naphthalene,
(2-10) 1,4-dibenzyloxynaphthalene,
(2-11) 1,4-diphenethyloxynaphthalene,
(2-12) 1,4-diglycidyloxynaphthalene,
(2-13) 1,4-bis(2-methylglycidyloxy)naphthalene,
(2-14) 4-methoxy-1-naphthol,
(2-15) 4-ethoxy-1-naphthol,
(2-16) 4-(n-propoxy)-1-naphthol,
(2-17) 4-(i-propoxy)-1-naphthol,
(2-18) 4-(n-butoxy)-1-naphthol,
(2-19) 4-(i-butoxy)-1-naphthol,
(2-20) 4-(n-octyloxy)-1-naphthol,
(2-21) 4-(2-ethylhexyloxy)-1-naphthol,
(2-22) 4-benzyloxy-1-naphthol,
(2-23) 4-phenethyloxy-1-naphthol,
(2-24) 4-glycidyloxy-1-naphthol and
(2-25) 4-(2-methylglycidyloxy)-1-naphthol.

Besides the above, examples of the naphthalene compound represented by the general formula (4) and the naphthalene compound represented by the general formula (6) further include the following compounds:
a compound in which positions, at which two substituents on the naphthalene ring in each of the compounds (2-1) to (2-25) are bound, are 1,2-positions;
a compound in which positions, at which two substituents on the naphthalene ring in each of the compounds (2-1) to (2-25) are bound, are 1,5-positions;
a compound in which positions, at which two substituents on the naphthalene ring in each of the compounds (2-1) to (2-25) are bound, are 1,6-positions;
a compound in which positions, at which two substituents on the naphthalene ring in each of the compounds (2-1) to (2-25) are bound, are 1,8-positions;
a compound in which positions, at which two substituents on the naphthalene ring in each of the compounds (2-1) to (2-25) are bound, are 2,3-positions;
a compound in which positions, at which two substituents on the naphthalene ring in each of the compounds (2-1) to (2-25) are bound, are 2,6-positions; and
a compound in which positions, at which two substituents on the naphthalene ring in each of the compounds (2-1) to (2-25) are bound, are 2,7-positions. In addition, examples of the compound of each of the general formulae (4) and (6), having an alkyl group as a substituent on the naphthalene ring, include the following compounds:
2-methyl-1,4-dimethoxynaphthalene, 2-methyl-1,4-diethoxynaphthalene, 2-methyl-1,4-bis(i-propoxy)naphthalene, 2-methyl-1,4-bis(n-butoxy)naphthalene, 2-methyl-1,4-bis(n-octyloxy)naphthalene, 2-methyl-1,4-bis(2-ethylhexyloxy)naphthalene, 2-methyl-1,4-dibenzyloxynaphthalene, 2-methyl-1,4-diphenethyloxynaphthalene, 2-methyl-1,4-diglycidyloxynaphthalene, 2-methyl-4-methoxy-1-naphthol, 2-methyl-4-ethoxy-1-naphthol, 2-methyl-4-(i-propoxy)-1-naphthol, 2-methyl-4-(n-butoxy)-1-naphthol, 2-methyl-4-(n-octyloxy)-1-naphthol, 2-methyl-4-(2-ethylhexyloxy)-1-naphthol, 2-methyl-4-benzyloxy-1-naphthol, 2-methyl-4-phenethyloxy-1-naphthol, 2-methyl-4-glycidyloxy-1-naphthol and 2-methyl-1,4-dihydroxynaphthalene.

Besides the above, examples of the compound of the general formula (4), having an alkyl group as a substituent on the naphthalene ring, include the following compounds:
3-methyl-1,2-dimethoxynaphthalene, 3-methyl-1,2-diethoxynaphthalene, 3-methyl-1,2-bis(i-propoxy)naphthalene, 3-methyl-1,2-bis(n-butoxy)naphthalene, 3-methyl-1,2-bis(n-octyloxy)naphthalene, 3-methyl-1,2-bis(2-ethylhexyloxy)naphthalene, 3-methyl-1,2-dibenzyloxynaphthalene, 3-methyl-1,2-diphenethyloxynaphthalene, 3-methyl-1,2-diglycidyloxynaphthalene, 3-methyl-1,2-dihydroxynaphthalene, 2-methyl-1,6-dimethoxynaphthalene, 2-methyl-1,6-diethoxynaphthalene, 2-methyl-1,6-bis(i-propoxy)naphthalene, 2-methyl-1,6-bis(n-butoxy)naphthalene, 2-methyl-1,6-bis(n-octyloxy)naphthalene, 2-methyl-1,6-bis(2-ethylhexyloxy)naphthalene, 2-methyl-1,6-dibenzyloxynaphthalene, 2-methyl-1,6-diphenethyloxynaphthalene, 2-methyl-1,6-diglycidyloxynaphthalene and 2-methyl-1,6-dihydroxynaphthalene.

Examples of the compound of the general formula (4) having an alkyl group as a substituent on the naphthalene ring further include the following compounds:
2-methyl-1,5-dimethoxynaphthalene, 2-methyl-1,5-diethoxynaphthalene, 2-methyl-1,5-bis(i-propoxy)naphthalene, 2-methyl-1,5-bis(n-butoxy)naphthalene, 2-methyl-1,5-bis(n-octyloxy)naphthalene, 2-methyl-1,5-bis(2-ethylhexyloxy)naphthalene, 2-methyl-1,5-dibenzyloxynaphthalene, 2-methyl-1,5-diphenethyloxynaphthalene, 2-methyl-1,5-diglycidyloxynaphthalene, 2-methyl-1,5-dihydroxynaphthalene, 3-methyl-2,7-dimethoxynaphthalene, 3-methyl-2,7-diethoxynaphthalene, 3-methyl-2,7-bis(i-propoxy)naphthalene, 3-methyl-2,7-bis(n-butoxy)naphthalene, 3-methyl-2,7-bis(n-octyloxy)naphthalene, 3-methyl-2,7-bis(2-ethylhexyloxy)naphthalene, 3-methyl-2,7-dibenzyloxynaphthalene, 3-methyl-2,7-diphenethyloxynaphthalene, 3-methyl-2,7-diglycidyloxynaphthalene, 3-methyl-2,7-dihydroxynaphthalene, 2-methyl-1,8-dimethoxynaphthalene, 2-methyl-1,8-diethoxynaphthalene, 2-methyl-1,8-bis(i-propoxy)naphthalene, 2-methyl-1,8-bis(n-butoxy)naphthalene, 2-methyl-1,8-bis(n-octyloxy)naphthalene, 2-methyl-1,8-bis(2-ethylhexyloxy)naphthalene, 2-methyl-1,8-dibenzyloxynaphthalene, 2-methyl-1,8-diphenethyloxynaphthalene, 2-methyl-1,8-diglycidyloxynaphthalene and 2-methyl-1,8-dihydroxynaphthalene.

Examples of the compound of the general formula (4) having an alkyl group as a substituent on the naphthalene ring further include the following compounds:
3-methyl-2,6-dimethoxynaphthalene, 3-methyl-2,6-diethoxynaphthalene, 3-methyl-2,6-bis(i-propoxy)naphthalene, 3-methyl-2,6-bis(n-butoxy)naphthalene, 3-methyl-2,6-bis(n-octyloxy)naphthalene, 3-methyl-2,6-bis(2-ethylhexyloxy)naphthalene, 3-methyl-2,6-dibenzyloxynaphthalene, 3-methyl-2,6-diphenethyloxynaphthalene, 3-methyl-2,6-diglycidyloxynaphthalene, 3-methyl-2,6-dihydroxynaphthalene, 5-methyl-2,3-dimethoxynaphthalene, 5-methyl-2,3-diethoxynaphthalene, 5-methyl-2,3-bis(i-propoxy)naphthalene, 5-methyl-2,3-bis(n-butoxy)naphthalene, 5-methyl-2,3-bis(n-octyloxy)naphthalene, 5-methyl-2,3-bis(2-ethylhexyloxy)naphthalene, 5-methyl-2,3-dibenzyloxynaphthalene, 5-methyl-2,3-diphenethyloxynaphthalene, 5-methyl-2,3-diglycidyloxynaphthalene and 5-methyl-2,3-dihydroxynaphthalene.

In addition, examples of the compound of each of the general formulae (4) and (6), having a halogen atom as a substituent on the naphthalene ring, include the following compounds:
2-chloro-1,4-dimethoxynaphthalene, 2-chloro-1,4-diethoxynaphthalene, 2-chloro-1,4-bis(i-propoxy)naphthalene, 2-chloro-1,4-bis(n-butoxy)naphthalene, 2-chloro-1,4-bis(n-octyloxy)naphthalene, 2-chloro-1,4-bis(2-ethylhexyloxy) naphthalene, 2-chloro-1,4-dibenzyloxynaphthalene, 2-chloro-1,4-diphenethyloxynaphthalene, 2-chloro-1,4-diglycidyloxynaphthalene, 2-chloro-4-methoxy-1-naphthol, 2-chloro-4-ethoxy-1-naphthol, 2-chloro-4-(i-propoxy)-1-naphthol, 2-chloro-4-(n-butoxy)-1-naphthol, 2-chloro-4-(n-octyloxy)-1-naphthol, 2-chloro-4-(2-ethylhexyloxy)-1-naphthol, 2-chloro-4-benzyloxy-1-naphthol, 2-chloro-4-phenethyloxy-1-naphthol, 2-chloro-4-glycidyloxy-1-naphthol and 2-chloro-1,4-dihydroxynaphthalene.

Besides the above, examples of the compound of the general formula (4), having a halogen atom as a substituent on the naphthalene ring, include the following compounds:
3-chloro-1,2-dimethoxynaphthalene, 3-chloro-1,2-diethoxynaphthalene, 3-chloro-1,2-bis(i-propoxy)naphthalene, 3-chloro-1,2-bis(n-butoxy)naphthalene, 3-chloro-1,2-bis(n-octyloxy)naphthalene, 3-chloro-1,2-bis(2-ethylhexyloxy)naphthalene, 3-chloro-1,2-dibenzyloxynaphthalene, 3-chloro-1,2-diphenethyloxynaphthalene, 3-chloro-1,2-diglycidyloxynaphthalene, 3-chloro-1,2-dihydroxynaphthalene, 2-chloro-1,6-dimethoxynaphthalene, 2-chloro-1,6-diethoxynaphthalene, 2-chloro-1,6-bis(i-propoxy) naphthalene, 2-chloro-1,6-bis(n-butoxy)naphthalene, 2-chloro-1,6-bis(n-octyloxy)naphthalene, 2-chloro-1,6-bis(2-ethylhexyloxy)naphthalene, 2-chloro-1,6-dibenzyloxynaphthalene, 2-chloro-1,6-diphenethyloxynaphthalene, 2-chloro-1,6-diglycidyloxynaphthalene, 2-chloro-1,6-dihydroxynaphthalene, 2-chloro-1,5-dimethoxynaphthalene, 2-chloro-1,5-diethoxynaphthalene, 2-chloro-1,5-bis(i-propoxy) naphthalene, 2-chloro-1,5-bis(n-butoxy)naphthalene, 2-chloro-1,5-bis(n-octyloxy)naphthalene, 2-chloro-1,5-bis(2-ethylhexyloxy)naphthalene, 2-chloro-1,5-dibenzyloxynaphthalene, 2-chloro-1,5-diphenethyloxynaphthalene, 2-chloro-1,5-diglycidyloxynaphthalene and 2-chloro-1,5-dihydroxynaphthalene.

Examples of the compound of the general formula (4) having a halogen atom as a substituent on the naphthalene ring further include the following compounds:
3-chloro-2,7-dimethoxynaphthalene, 3-chloro-2,7-diethoxynaphthalene, 3-chloro-2,7-bis(i-propoxy)naphthalene, 3-chloro-2,7-bis(n-butoxy)naphthalene, 3-chloro-2,7-bis(n-octyloxy)naphthalene, 3-chloro-2,7-bis(2-ethylhexyloxy)naphthalene, 3-chloro-2,7-dibenzyloxynaphthalene, 3-chloro-2,7-diphenethyloxynaphthalene, 3-chloro-2,7-diglycidyloxynaphthalene, 3-chloro-2,7-dihydroxynaphthalene, 2-chloro-1,8-dimethoxynaphthalene, 2-chloro-1,8-diethoxynaphthalene, 2-chloro-1,8-bis(i-propoxy)naphthalene, 2-chloro-1,8-bis(n-butoxy)naphthalene, 2-chloro-1,8-bis(n-octyloxy)naphthalene, 2-chloro-1,8-bis(2-ethylhexyloxy)naphthalene, 2-chloro-1,8-dibenzyloxynaphthalene, 2-chloro-1,8-diphenethyloxynaphthalene, 2-chloro-1,8-diglycidyloxynaphthalene, 2-chloro-1,8-dihydroxynaphthalene, 3-chloro-2,6-dimethoxynaphthalene, 3-chloro-2,6-diethoxynaphthalene, 3-chloro-2,6-bis(i-propoxy)naphthalene, 3-chloro-2,6-bis(n-butoxy)naphthalene, 3-chloro-2,6-bis(n-octyloxy)naphthalene, 3-chloro-2,6-bis(2-ethylhexyloxy)naphthalene, 3-chloro-2,6-dibenzyloxynaphthalene, 3-chloro-2,6-diphenethyloxynaphthalene and 3-chloro-2,6-diglycidyloxynaphthalene.

In addition, examples of the compound of each of the general formulae (4) and (6), having alkoxy as a substituent on the naphthalene ring, include the following compounds:
1,2,4-trimethoxynaphthalene, 2-methoxy-1,4-diethoxynaphthalene, 2-methoxy-1,4-bis(i-propoxy)naphthalene, 2-methoxy-1,4-bis(n-butoxy)naphthalene, 2-methoxy-1,4-bis(n-octyloxy)naphthalene, 2-methoxy-1,4-bis(2-ethylhexyloxy) naphthalene, 2-methoxy-1,4-dibenzyloxynaphthalene, 2-methoxy-1,4-diphenethyloxynaphthalene, 2-methoxy-1,4-diglycidyloxynaphthalene, 2-methoxy-4-methoxy-1-naphthol, 2-methoxy-4-ethoxy-1-naphthol, 2-methoxy-4-(i-propoxy)-1-naphthol, 2-methoxy-4-(n-butoxy)-1-naphthol, 2-methoxy-4-(n-octyloxy)-1-naphthol, 2-methoxy-4-(2-ethylhexyloxy)-1-naphthol, 2-methoxy-4-benzyloxy-1-naphthol, 2-methoxy-4-phenethyloxy-1-naphthol, 2-methoxy-4-glycidyloxy-1-naphthol and 2-methoxy-1, 4-dihydroxynaphthalene.

Besides the above, examples of the compound of the general formula (4), having alkoxy as a substituent on the naphthalene ring, include the following compounds: 1,2,3-trimethoxynaphthalene, 3-methoxy-1,2 diethoxynaphthalene, 3-methoxy-1,2-bis(i-propoxy)naphthalene, 3-methoxy-1,2-bis(n-butoxy)naphthalene, 3-methoxy-1,2-bis(n-octyloxy)naphthalene, 3-methoxy-1,2-bis(2-ethylhexyloxy)naphthalene, 3-methoxy-1,4-dibenzyloxynaphthalene, 3-methoxy-1,4-diphenethyloxynaphthalene, 3-methoxy-1,2-diglycidyloxynaphthalene, 3-methoxy-1,2-dihydroxynaphthalene, 1,2,6-trimethoxynaphthalene, 2-methoxy-1,6-diethoxynaphthalene, 2-methoxy-1,6-bis(i-propoxy)naphthalene, 2-methoxy-1,6-bis(n-butoxy)naphthalene, 2-methoxy-1,6-bis(n-octyloxy)naphthalene, 2-methoxy-1,6-bis(2-ethylhexyloxy)naphthalene, 2-methoxy-1,6-dibenzyloxynaphthalene, 2-methoxy-1,6-1,4-diphenethyloxynaphthalene, 2-methoxy-1,6-diglycidyloxynaphthalene, 2-methoxy-1,6-dihydroxynaphthalene, 1,2,5-trimethoxynaphthalene, 2-methoxy-1,5-diethoxynaphthalene, 2-methoxy-1,5-bis(i-propoxy)naphthalene, 2-methoxy-1,5-bis(n-butoxy)naphthalene, 2-methoxy-1,5-bis(n-octyloxy)naphthalene, 2-methoxy-1,5-bis(2-ethylhexyloxy)naphthalene, 2-methoxy-1,5-dibenzyloxynaphthalene, 2-methoxy-1,5-diphenethyloxynaphthalene, 2-methoxy-1,5-diglycidyloxynaphthalene and 2-methoxy-1,5-dihydroxynaphthalene.

Examples of the compound of the general formula (4) having alkoxy as a substituent on the naphthalene ring further include the following compounds:
3-methoxy-2,7-diethoxynaphthalene, 3-methoxy-2,7-bis(i-propoxy)naphthalene, 3-methoxy-2,7-bis(n-butoxy)naphthalene, 3-methoxy-2,7-bis(n-octyloxy)naphthalene, 3-methoxy-2,7-bis(2-ethylhexyloxy)naphthalene, 3-methoxy-2,7-dibenzyloxynaphthalene, 3-methoxy-2,7-diphenethyloxynaphthalene, 3-methoxy-2,7-diglycidyloxynaphthalene, 3-methoxy-2,7-dihydroxynaphthalene, 1,2,8-trimethoxynaphthalene, 2-methoxy-1,8-diethoxynaphthalene, 2-methoxy-1,8-bis(i-propoxy)naphthalene, 2-methoxy-1,8-bis(n-butoxy)naphthalene, 2-methoxy-1,8-bis(n-octyloxy)naphthalene, 2-methoxy-1,8-bis(2-ethylhexyloxy)naphthalene, 2-methoxy-1,8-dibenzyloxynaphthalene, 2-methoxy-1,8-diphenethyloxynaphthalene, 2-methoxy-1,8-diglycidyloxynaphthalene, 2-methoxy-1,8-dihydroxynaphthalene, 2,3,6-trimethoxynaphthalene, 3-methoxy-2,6-diethoxynaphthalene, 3-methoxy-2,6-bis(i-propoxy)naphthalene, 3-methoxy-2,6-bis(n-butoxy)naphthalene, 3-methoxy-2,6-bis(n-octyloxy)naphthalene, 3-methoxy-2,6-bis(2-ethylhexyloxy)naphthalene, 3-methoxy-2,6-dibenzyloxynaphthalene, 3-methoxy-2,6-diphenethyloxynaphthalene, 3-methoxy-2,6-diglycidyloxynaphthalene and 3-methoxy-2,6-dihydroxynaphthalene.

In addition, examples of the compound of each of the general formulae (4) and (6), having aryloxy as a substituent on the naphthalene ring, include the following compounds:
2-phenoxy-1,4-dimethoxynaphthalene, 2-phenoxy-1,4-diethoxynaphthalene, 2-phenoxy-1,4-bis(i-propoxy)naphthalene, 2-phenoxy-1,4-bis(n-butoxy)naphthalene, 2-phenoxy-1,4-bis(n-octyloxy)naphthalene, 2-phenoxy-1,4-bis(2-ethylhexyloxy)naphthalene, 2-phenoxy-1,4-dibenzyloxynaphthalene, 2-phenoxy-1,4-diphenethyloxynaphthalene, 2-phenoxy-1,4-diglycidyloxynaphthalene, 2-phenoxy-4-methoxy-1-naphthol, 2-phenoxy-4-ethoxy-1-naphthol, 2-phenoxy-4-(i-propoxy)-1-naphthol, 2-phenoxy-4-(n-butoxy)-1-naphthol, 2-phenoxy-4-(n-octyloxy)-1-naphthol, 2-phenoxy-4-(2-ethylhexyloxy)-1-naphthol, 2-phenoxy-4-benzyloxy-1-naphthol, 2-phenoxy-4-phenethyloxy-1-naphthol, 2-phenoxy-4-glycidyloxy-1-naphthol and 2-phenoxy-1, 4-dihydroxynaphthalene.

Besides the above, examples of the compound of the general formula (4), having aryloxy as a substituent on the naphthalene ring, include the following compounds:
3-phenoxy-1,2-dimethoxynaphthalene, 3-phenoxy-1,2-diethoxynaphthalene, 3-phenoxy-1,2-bis(i-propoxy)naphthalene, 3-phenoxy-1,2-bis(n-butoxy)naphthalene, 3-phenoxy-1,2-bis(n-octyloxy)naphthalene, 3-phenoxy-1,2-bis(2-ethylhexyloxy)naphthalene, 3-phenoxy-1,2-dibenzyloxynaphthalene, 3-phenoxy-1,2-diphenethyloxynaphthalene, 3-phenoxy-1,2-diglycidyloxynaphthalene, 2-phenoxy-1,6-dimethoxynaphthalene, 2-phenoxy-1,6-diethoxynaphthalene, 2-phenoxy-1,6-bis(i-propoxy)naphthalene, 2-phenoxy-1,6-bis(n-butoxy)naphthalene, 2-phenoxy-1,6-bis(n-octyloxy)naphthalene, 2-phenoxy-1,6-bis(2-ethylhexyloxy)naphthalene, 2-phenoxy-1,6-dibenzyloxynaphthalene, 2-phenoxy-1,6-diphenethyloxynaphthalene, 2-phenoxy-1,6-diglycidyloxynaphthalene, 2-phenoxy-1,5-dimethoxynaphthalene, 2-phenoxy-1,5-diethoxynaphthalene, 2-phenoxy-1,5-bis(i-propoxy)naphthalene, 2-phenoxy-1,5-bis(n-butoxy)naphthalene, 2-phenoxy-1,5-bis(n-octyloxy)naphthalene, 2-phenoxy-1,5-bis(2-ethylhexyloxy)naphthalene, 2-phenoxy-1,5-dibenzyloxynaphthalene, 2-phenoxy-1,5-diphenethyloxynaphthalene and 2-phenoxy-1,5-diglycidyloxynaphthalene.

Examples of the compound of the general formula (4) having aryloxy as a substituent on the naphthalene ring further include the following compounds:
3-phenoxy-2,7-dimethoxynaphthalene, 3-phenoxy-2,7-diethoxynaphthalene, 3-phenoxy-2,7-bis(i-propoxy)naphthalene, 3-phenoxy-2,7-bis(n-butoxy)naphthalene, 3-phenoxy-2,7-bis(n-octyloxy)naphthalene, 3-phenoxy-2,7-bis(2-ethylhexyloxy)naphthalene, 3-phenoxy-2,7-dibenzyloxynaphthalene, 3-phenoxy-2,7-diphenethyloxynaphthalene, 3-phenoxy-2,7-diglycidyloxynaphthalene, 2-phenoxy-1,8-dimethoxynaphthalene, 2-phenoxy-1,8-diethoxynaphthalene, 2-phenoxy-1,8-bis(i-propoxy)naphthalene, 2-phenoxy-1,8-bis(n-butoxy)naphthalene, 2-phenoxy-1,8-bis(n-octyloxy)naphthalene, 2-phenoxy-1,8-bis(2-ethylhexyloxy)naphthalene, 2-phenoxy-1,8-dibenzyloxynaphthalene, 2-phenoxy-1,8-diphenethyloxynaphthalene, 2-phenoxy-1,8-diglycidyloxynaphthalene, 3-phenoxy-2,6-dimethoxynaphthalene, 3-phenoxy-2,6-diethoxynaphthalene, 3-phenoxy-2,6-bis(i-propoxy)naphthalene, 3-phenoxy-2,6-bis(n-butoxy)naphthalene, 3-phenoxy-2,6-bis(n-octyloxy)naphthalene, 3-phenoxy-2,6-bis(2-ethylhexyloxy)naphthalene, 3-phenoxy-2,6-dibenzyloxynaphthalene, 3-phenoxy-2,6-diphenethyloxynaphthalene and 3-phenoxy-2,6-diglycidyloxynaphthalene.

The compound represented by the general formula (5) and the compound represented by the general formula (7) are described.

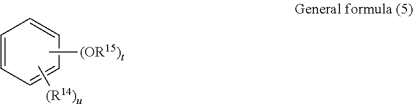

In the general formula (5), R²⁴ represents an alkyl group, an aralkyl group, an alkoxy group, an aryloxy group or a halogen atom, u represents an integer of 0 to 4, R²⁵ represents a hydrogen atom, an alkyl group having 1 to 9 carbon atoms optionally substituted with an oxygen atom, a glycidyl group or an aralkyl group, t represents an integer of 1 or 2, each R²⁴ is independently defined as above when a plurality of R¹⁴(s) are present, and each R²⁵ is independently defined as above when a plurality of R¹⁵(s) are present. Alternatively,

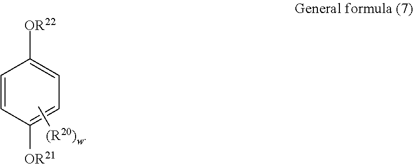

The compound represented by the general formula (5) can be the compound represented by the general formula (7).

In the general formula (7), R²⁰ represents an alkyl group, an aralkyl group, an alkoxy group, an aryloxy group or a halogen atom, w represents an integer of 0 to 4, R²² and R²² each independently represent a hydrogen atom, an alkyl group having 1 to 9 carbon atoms optionally substituted with an oxygen atom, a glycidyl group or an aralkyl group, and each R²⁰ is independently defined as above when a plurality of R²⁰ (s) are present.

In each of the general formulae (5) and (7), examples of the alkyl group having 1 or more and 9 or less carbon atoms optionally substituted with a substituent having an oxygen atom in each of R¹⁵, R²¹ and R²² include a linear or branched alkyl group in which at least one hydrogen atom may be substituted with a substituent having an oxygen atom. Examples of the substituent having an oxygen atom include a hydroxy group, alkyloxy groups having 1 to 8 carbon atoms, such as a methoxy group and an ethoxy group, and aryloxy groups such as a phenoxy group. Examples of the alkyl group having 1 or more and 9 or less carbon atoms optionally substituted with the substituent having an oxygen atom include a methyl group, an ethyl group, an n-propyl group, an i-propyl group, an n-butyl group, an i-butyl group, an n-pentyl group, an n-hexyl group, an n-heptyl group, an n-octyl group, a 2-ethylhexyl group, an n-nonyl group, a 2-hydroxyethyl group, a 3-hydroxyethyl group, a 2-hydroxypropyl group, a 2-methoxyethyl group, a 2-ethoxyethyl group and a 2-phenoxyethyl group.

Examples of the glycidyl group include a glycidyl group and a 2-methylglycidyl group.

Examples of the aralkyl group include a benzyl group.

In each of the general formulae (5) and (7), examples of the halogen atom in each of R¹⁴ and R²⁰ include a fluorine atom, a chlorine atom and a bromine atom.

Examples of the alkyl group include linear or branched alkyl groups having 1 to 4 carbon atoms, such as a methyl group, an ethyl group and a t-butyl group. Examples of the aralkyl group include a benzyl group and a phenethyl group, examples of the alkoxy group include a methoxy group and an ethoxy group, and examples of the aryloxy group include a phenoxy group.

Examples of the benzene compound represented by the general formula (5) and the benzene compound represented by the general formula (7) include the following compounds:
1,4-dihydroxybenzene, 1,4-dimethoxybenzene, 1,4-diethoxybenzene, 1,4-bis(i-propoxy)benzene, 1,4-bis(n-butoxy)benzene, 1,4-bis(n-octyloxy)benzene, 1,4-bis(2-ethylhexyloxy) benzene, 1,4-dibenzyloxybenzene, 1,4-diphenethyloxybenzene, 1,4-diglycidyloxybenzene, 4-methoxy-1-phenol, 4-ethoxy-1-phenol, 4-(i-propoxy)-1-phenol, 4-(n-butoxy)-1-phenol, 4-(n-octyloxy)-1-phenol, 4-(2-ethylhexyloxy)-1-phenol, 4-benzyloxy-1-phenol, 4-phenethyloxy-1-phenol and 4-glycidyloxy-1-phenol.

Besides the above, examples of the benzene compound represented by the general formula (5) include the following compounds:
1,3-dimethoxybenzene, 1,3-diethoxybenzene, 1,3-bis(i-propoxy)benzene, 1,3-bis(n-butoxy)benzene, 1,3-bis(n-octyloxy)benzene, 1,3-bis(2-ethylhexyloxy)benzene, 1,3-dibenzyloxybenzene, 1,3-diphenethyloxybenzene, 1,3-diglycidyloxybenzene, resorcin, 1,2-dimethoxybenzene, 1,2-diethoxybenzene, 1,2-bis(i-propoxy)benzene, 1,2-bis(n-butoxy)benzene, 1,2-bis(n-octyloxy)benzene, 1,2-bis(2-ethylhexyloxy)benzene, 1,2-dibenzyloxybenzene, 1,2-diphenethyloxybenzene, 1,2-diglycidyloxybenzene and catechol.

In addition, examples of the compound of each of the general formulae (5) and (7) having an alkyl group as a substituent on the benzene ring include the following compounds:
2-methyl-1,4-dimethoxybenzene, 2-methyl-1,4-diethoxybenzene, 2-methyl-1,4-bis(i-propoxy)benzene, 2-methyl-1,4-bis(n-butoxy)benzene, 2-methyl-1,4-bis(n-octyloxy)benzene, 2-methyl-1,4-bis(2-ethylhexyloxy)benzene, 2-methyl-1,4-dibenzyloxybenzene, 2-methyl-1,4-diphenethyloxybenzene, 2-methyl-1,4-diglycidyloxybenzene, 2-methyl-4-methoxy-1-phenol, 2-methyl-4-ethoxy-1-phenol, 2-methyl-4-(i-propoxy)-1-phenol, 2-methyl-4-(n-butoxy)-1-phenol, 4-(n-octyloxy)-1-phenol, 2-methyl-4-(2-ethylhexyloxy)-1-phenol, 2-methyl-4-benzyloxy-1-phenol, 2-methyl-4-phenethyloxy-1-phenol, 2-methyl-4-diglycidyloxy-1-phenol and 2-methyl-1, 4-dihydroxybenzene.

Besides the above, examples of the compound of the general formula (5) having an alkyl group as a substituent on the benzene ring include the following compounds:
2-methyl-1,3-dimethoxybenzene, 2-methyl-1,3-diethoxybenzene, 2-methyl-1,3-bis(i-propoxy)benzene, 2-methyl-1,3-bis(n-butoxy)benzene, 2-methyl-1,3-bis(n-octyloxy)benzene, 2-methyl-1,3-bis(2-ethylhexyloxy)benzene, 2-methyl-1,3-dibenzyloxybenzene, 2-methyl-1,3-diphenethyloxybenzene, 2-methyl-1,3-diglycidyloxybenzene, 2-methylresorcin, 3-methyl-1,2-dimethoxybenzene, 3-methyl-1,2-diethoxybenzene, 3-methyl-1,2-bis(i-propoxy)benzene, 3-methyl-1,2-bis(n-butoxy)benzene, 3-methyl-1,2-bis(n-octyloxy)benzene, 3-methyl-1,2-bis(2-ethylhexyloxy)benzene, 3-methyl-1,2-dibenzyloxybenzene, 3-methyl-1,2-diphenethyloxybenzene, 3-methyl-1,2-diglycidyloxybenzene and 3-methylcatechol.

In addition, examples of the compound of each of the general formulae (5) and (7) having a halogen atom as a substituent on the benzene ring include the following compounds:
2-chloro-1,4-dimethoxybenzene, 2-chloro-1,4-diethoxybenzene, 2-chloro-1,4-bis(i-propoxy)benzene, 2-chloro-1,4-bis(n-butoxy)benzene, 2-chloro-1,4-bis(n-octyloxy)benzene, 2-chloro-1,4-bis(2-ethylhexyloxy)benzene, 2-chloro-1,4-dibenzyloxybenzene, 2-chloro-1,4-diphenethyloxybenzene, 2-chloro-4-methoxy-1-phenol, 2-chloro-4-ethoxy-1-phenol, 2-chloro-4-(i-propoxy)-1-phenol, 2-chloro-4-(n-butoxy)-1-phenol, 2-chloro-4-(n-octyloxy)-1-phenol, 2-chloro-4-(2-ethylhexyloxy)-1-phenol, 2-chloro-4-benzyloxy-1-phenol, 2-chloro-4-phenethyloxy-1-phenol, 2-chloro-4-diglycidyloxy-1-phenol and 2-chloro-1,4-dihydroxybenzene.

Besides the above, examples of the compound of the general formula (5) having a halogen atom as a substituent on the benzene ring include the following compounds:
2-chloro-1,3-dimethoxybenzene, 2-chloro-1,3-diethoxybenzene, 2-chloro-1,3-bis(i-propoxy)benzene, 2-chloro-1,3-bis(n-butoxy)benzene, 2-chloro-1,3-bis(n-octyloxy) benzene, 2-chloro-1,3-bis(2-ethylhexyloxy)benzene, 2-chloro-1,3-dibenzyloxybenzene, 2-chloro-1,3-diphenethyloxybenzene, 2-chloro-1,3-diglycidyloxybenzene, 3-chloro-1,2-dimethoxybenzene, 3-chloro-1,2-diethoxybenzene, 3-chloro-1,2-bis(i-propoxy)benzene, 3-chloro-1,2-bis(n-butoxy)benzene, 3-chloro-1,2-bis(n-octyloxy)benzene, 3-chloro-1,2-bis(2-ethylhexyloxy) benzene, 3-chloro-1,2-dibenzyloxybenzene, 3-chloro-1,2-diphenethyloxybenzene and 3-chloro-1,2-diglycidyloxybenzene.

In addition, examples of the compound of each of the general formulae (5) and (7) having alkoxy as a substituent on the benzene ring include the following compounds:
1,2,4-trimethoxybenzene, 2-methoxy-1,4-diethoxybenzene, 2-methoxy-1,4-bis(i-propoxy)benzene, 2-methoxy-1,4-bis(n-butoxy)benzene, 2-methoxy-1,4-bis(n-octyloxy)benzene, 2-methoxy-1,4-bis(2-ethylhexyloxy)benzene, 2-methoxy-1,4-dibenzyloxybenzene, 2-methoxy-1,4-diphenethyloxybenzene and 2-methoxy-1,4-diglycidyloxybenzene.

Besides the above, examples of the compound of the general formula (5) having alkoxy as a substituent on the benzene ring include the following compounds:
1,2,3-trimethoxybenzene, 3-methoxy-1,2-diethoxybenzene, 3-methoxy-1,2-bis(i-propoxy)benzene, 3-methoxy-1,2-bis(n-butoxy)benzene, 3-methoxy-1,2-bis(n-octyloxy)benzene, 3-methoxy-1,2-bis(2-ethylhexyloxy)benzene, 3-methoxy-1,2-dibenzyloxybenzene, 3-methoxy-1,2-diphenethyloxybenzene, 3-methoxy-1,2-diglycidyloxybenzene, 2-methoxy-1,3-diethoxybenzene, 2-methoxy-1,3-bis(i-propoxy)benzene, 2-methoxy-1,3-bis(n-butoxy)benzene, 2-methoxy-1,3-bis(n-octyloxy)benzene, 2-methoxy-1,3-bis(2-ethylhexyloxy)benzene, 2-methoxy-1, 3-dibenzyloxybenzene, 2-methoxy-1,3-diphenethyloxybenzene and 2-methoxy-1,3-diglycidyloxybenzene.

In addition, examples of the compound of each of the general formulae (5) and (7) having aryloxy as a substituent on the benzene ring include the following compounds:
2-phenoxy-1,4-dimethoxybenzene, 2-phenoxy-1,4-diethoxybenzene, 2-phenoxy-1,4-bis(i-propoxy)benzene, 2-phenoxy-1,4-bis(n-butoxy)benzene, 2-phenoxy-1,4-bis(n-octyloxy)benzene, 2-phenoxy-1,4-bis(2-ethylhexyloxy)benzene, 2-phenoxy-1,4-dibenzyloxybenzene, 2-phenoxy-1,4-diphenethyloxybenzene and 2-phenoxy-1,4-diglycidyloxybenzene.

Besides the above, examples of the compound of the general formula (5) having aryloxy as a substituent on the benzene ring include the following compounds: 3-phenoxy-1,2-dimethoxybenzene, 3-phenoxy-1,2-diethoxybenzene, 3-phenoxy-1,2-bis(i-propoxy)benzene, 3-phenoxy-1,2-bis(n-butoxy)benzene, 3-phenoxy-1,2-bis(n-octyloxy)benzene, 3-phenoxy-1,2-bis(2-ethylhexyloxy)benzene, 3-phenoxy-1,2-dibenzyloxybenzene, 3-phenoxy-1,2-diphenethyloxybenzene, 3-phenoxy-1,2-diglycidyloxybenzene, 2-phenoxy-1,3-dimethoxybenzene, 2-phenoxy-1,3-diethoxybenzene, 2-phenoxy-1,3-bis(i-propoxy)benzene, 2-phenoxy-1,3-bis(n-butoxy)benzene, 2-phenoxy-1,3-bis(n-octyloxy)benzene, 2-phenoxy-1,3-bis(2-ethylhexyloxy)benzene, 2-phenoxy-1,3-dibenzyloxybenzene, 2-phenoxy-1,3-diphenethyloxybenzene and 2-phenoxy-1,3-diglycidyloxybenzene.

Among such naphthalene compounds or benzene compounds represented by the general formulae (2) to (5), 1,4-dimethoxynaphthalene, 1,4-diethoxynaphthalene, 1,4-bis(n-propoxy)naphthalene, 1,4-bis(i-propoxy)naphthalene, 1,4-bis(n-butoxy)naphthalene, 1,4-bis(i-butoxy)naphthalene, 1,4-dimethoxybenzene, 1,4-diethoxybenzene, 1,4-bis(n-propoxy)benzene, 1,4-bis(i-propoxy)benzene, 1,4-bis(n-butoxy)benzene or 1,4-bis(i-butoxy)benzene can be adopted because of being easily synthesized, having a high sensitization effect of the ultraviolet curable liquid composition, and also enhancing storage stability when used in combination with the compound represented by the general formula (1). In particular, 1,4-dimethoxynaphthalene, 1,4-diethoxynaphthalene, 1,4-bis(n-propoxy)naphthalene, 1,4-bis(i-propoxy)naphthalene, 1,4-bis(n-butoxy)naphthalene or 1,4-bis(i-butoxy)naphthalene can be adopted because of having a higher sensitization effect of the ultraviolet curable liquid composition and exhibiting an excellent storage stability when used in combination with the compound represented by the general formula (1).

In the present invention, the compound selected from the group consisting of the compound represented by the general formula (4) and the compound represented by the general formula (5) can be used singly or in combinations of two or more.

The total content of the compound selected from the group consisting of the compound represented by the general formula (4) and the compound represented by the general formula (5) in the entire ultraviolet curable liquid composition is defined as Co by mass, and the content of the compound represented by the general formula (1) in the entire ultraviolet curable liquid composition is defined as A% by mass. The C/A here is preferably 1.0 or more, further preferably 5.0 or more. When the compound selected from the group consisting of the compound represented by the general formula (4) and the compound represented by the general formula (5) is used in combination of two or more, the total content of two or more is defined as Co by mass. When the C/A is 1.0 or more, the amount of an electrons that transfer from the compound selected from the group consisting of the compound represented by the general formula (2) and the compound represented by the general formula (3) via the compound selected from the group consisting of the compound represented by the general formula (4) and the compound represented by the general formula (5) to the photopolymerization initiator can be increased to further enhance sensitivity and to further enhance storage stability.

[Vinyl Ether Compound]

In the ultraviolet curable liquid composition of the present invention, as one feature, a vinyl ether compound is used as a polymerizable liquid monomer. The vinyl ether compound can be used to thereby provide an ultraviolet curable liquid composition having high resistivity, low viscosity and high sensitivity.

As the polymerizable liquid monomer, an acrylic monomer, a cyclic ether monomer such as epoxy and oxetane monomers, and the like are widely used.

The acrylic monomer, however, has the bias in electron density in the molecule, and such bias causes the electrostatic interaction between molecules to make the ultraviolet curable liquid composition difficult to have low viscosity. Accordingly, the acrylic monomer is difficult to use in an application as a component of a liquid developer or an inkjet ink having low viscosity, which is an object of the present invention.

In addition, the bias in electron density in the molecule is supposed to lead to difficulty of achievement of a high resistivity in a liquid composition including the acrylic monomer. Moreover, the cyclic ether monomer has again difficulty in providing a liquid composition having high resistivity, and furthermore the cyclic ether monomer is considerably low in reaction rate as compared with the vinyl ether compound. Accordingly, the cyclic ether monomer is also difficult to use in an application as a component of a liquid developer or an inkjet ink, which is an object of the present invention. The present inventors suppose the following: when the vinyl ether compound is used as the polymerizable liquid monomer, a small bias in electron density in the molecule can allow an ultraviolet curable liquid composition having low viscosity, high resistivity and high sensitivity to be provided.

In the present invention, furthermore, one aspect can be provided in which the cationically polymerizable liquid monomer is a vinyl ether compound having no hetero atom in a moiety other than the vinyl ether group. The term “hetero atom” here refers to any atom other than a carbon atom and a hydrogen atom. When a hetero atom is contained in the vinyl ether compound, the difference in electronegativity between a hetero atom and a carbon atom may cause the bias in electron density in the molecule to be easily generated, or may cause an unshared electron pair or an empty electron orbital, which a hetero atom has, to be a passage for conduction electrons or holes. Therefore, the resistance value of a liquid composition in which a vinyl ether compound having a hetero atom is used may be lower than the resistance value of a liquid composition in which the vinyl ether compound having no hetero atom is used. Accordingly, in order to efficiently control the resistance value of the liquid composition, the vinyl ether compound having no hetero atom in a moiety other than the vinyl ether group can be used.

Furthermore, in the present invention, one aspect can be provided in which the cationically polymerizable liquid monomer is a vinyl ether compound having no carbon-carbon double bond in a moiety other than the vinyl ether group. While a carbon-carbon double bond has an electron occupied orbital with a high energy level and an electron unoccupied orbital with a low energy level, such orbitals may serve as a passage for electrons or holes. Therefore, the resistance value of a liquid composition in which a vinyl ether compound having a carbon-carbon double bond in a moiety other than the vinyl ether group is used may be lower than the resistance value of a liquid composition in which the vinyl ether compound not having such a double bond is used. Accordingly, in order to efficiently control the resistance value of the liquid composition, the vinyl ether compound not having such a double bond in a moiety other than the vinyl ether group can be used.

The cationically polymerizable liquid monomer can further contain a vinyl ether compound having a cyclic structure in the molecule. The vinyl ether compound having a cyclic structure in the molecule can be used to thereby impart excellent sensitivity and strength after curing. Examples of the vinyl ether compound having a cyclic structure in the molecule include an aromatic vinyl ether compound as well as a vinyl ether compound having an alicyclic backbone. The resistance value of a liquid composition in which an aromatic vinyl ether compound is used may be lower than the resistance value of a liquid composition in which an alicyclic vinyl ether compound is used. Accordingly, in order to efficiently control the resistance value of the liquid composition, a vinyl ether compound having an alicyclic backbone can be adopted.

Furthermore, the vinyl ether compound having a cyclic structure in the molecule can be a compound which has at least one, preferably 1 to 4 vinyl ether groups, and in which the moiety other than the vinyl ether group is a hydrocarbon group having 6 to 18 carbon atoms. The hydrocarbon group used here can be selected from the group consisting of hydrocarbon groups included in exemplary compounds B-1 to B-30 described later.

One aspect can also be provided in which the vinyl ether compound having a cyclic structure in the molecule and a vinyl ether compound having no cyclic structure in the molecule are used in combination as the cationically polymerizable liquid monomer. In such a case, the ratio of the content of the vinyl ether compound having a cyclic structure in the molecule to the total amount of the vinyl ether compounds is preferably 10% by mass or more, further preferably 20% by mass or more.

The molecular weight of each of the vinyl ether compound having a cyclic structure in the molecule and the vinyl ether compound having no cyclic structure in the molecule, as the cationically polymerizable monomer, is preferably 130 or more, further preferably 170 or more. When the molecular weight is 130 or more, volatility of the cationically polymerizable monomer can be reduced and the amount of radiation can be reduced. While the upper limit of the molecular weight of the cationically polymerizable monomer to be used is not defined, vinyl ether having a molecular weight of 300 or less can be used as a main component because low viscosity of the liquid composition is easily achieved.

Examples of the vinyl ether compound having no cyclic structure include a compound represented by the following formula (A).

CH₂═CH—O—Ra (A)

Ra represents an alkyl group having 3 to 19 carbon atoms optionally substituted with a vinyloxy group or a glycidyloxy group, or —(CHR″—CH₂—O)n-CH═CH₂ [n represents 2 or 3 and R″ represents a hydrogen atom or a methyl group]. The alkyl group substituted with a vinyloxy group can have 1 to 4 vinyloxy groups.

Examples of the vinyl ether compound having a cyclic structure include a compound represented by the following formula (B).

CH₂═CH—Rb-Rc (B)

Rb represents a direct bond, an alkylene group having 1 to 3 carbon atoms or an alkenyl group having 3 carbon atoms. Rc represents any of the following cyclic structures.

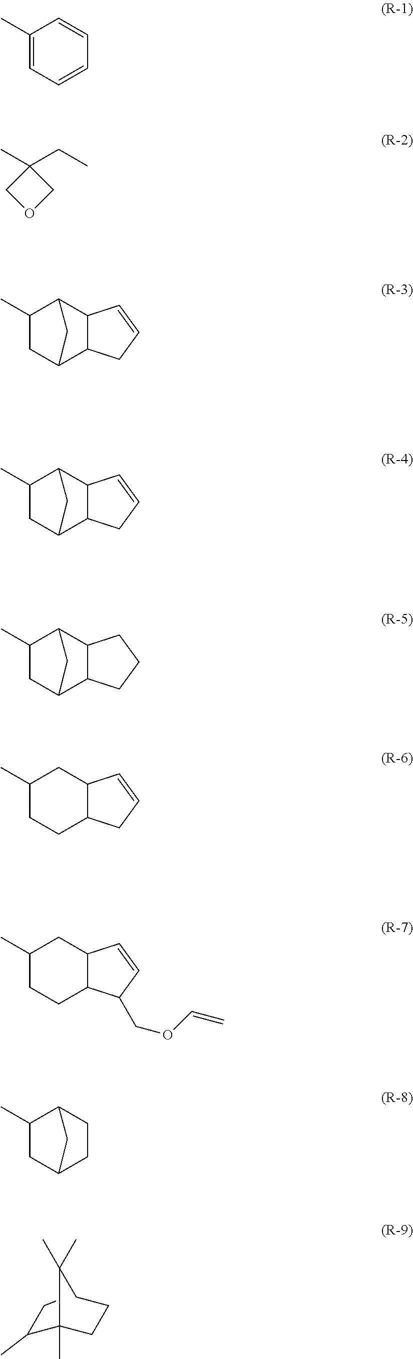

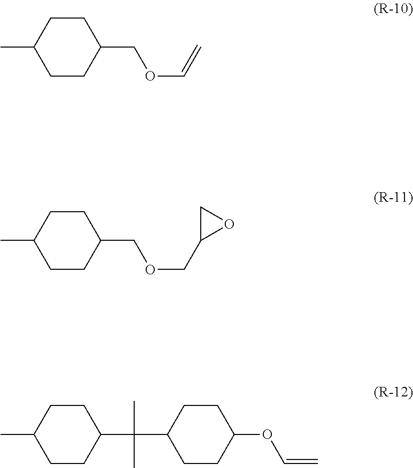

Specific examples [exemplary compounds B-1 to B-30] of the vinyl ether compound that can be used in the present invention include the following, but the vinyl ether compound is not limited to such specific examples in the present invention.

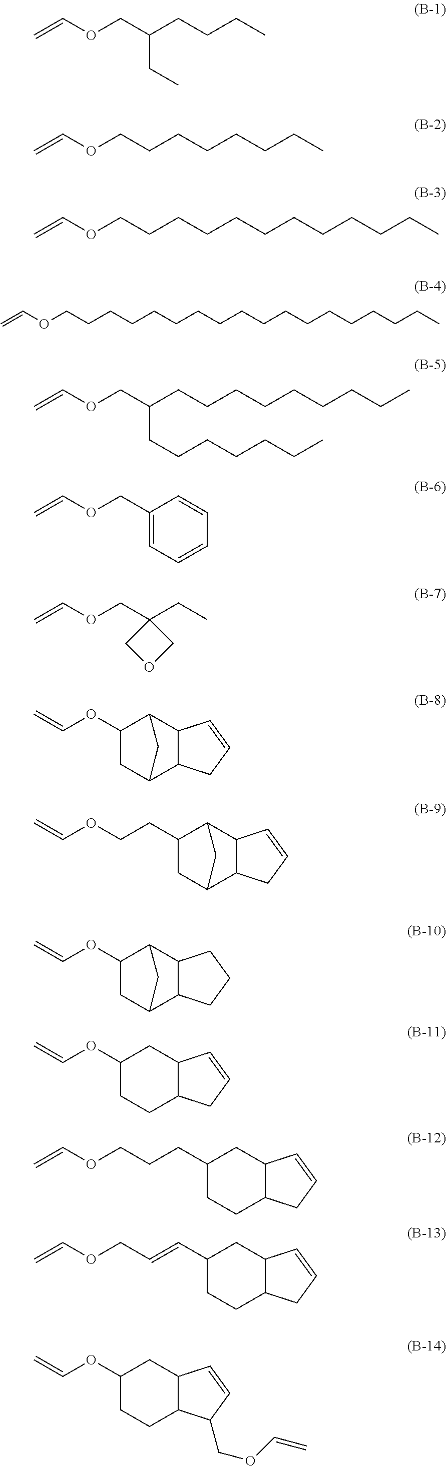

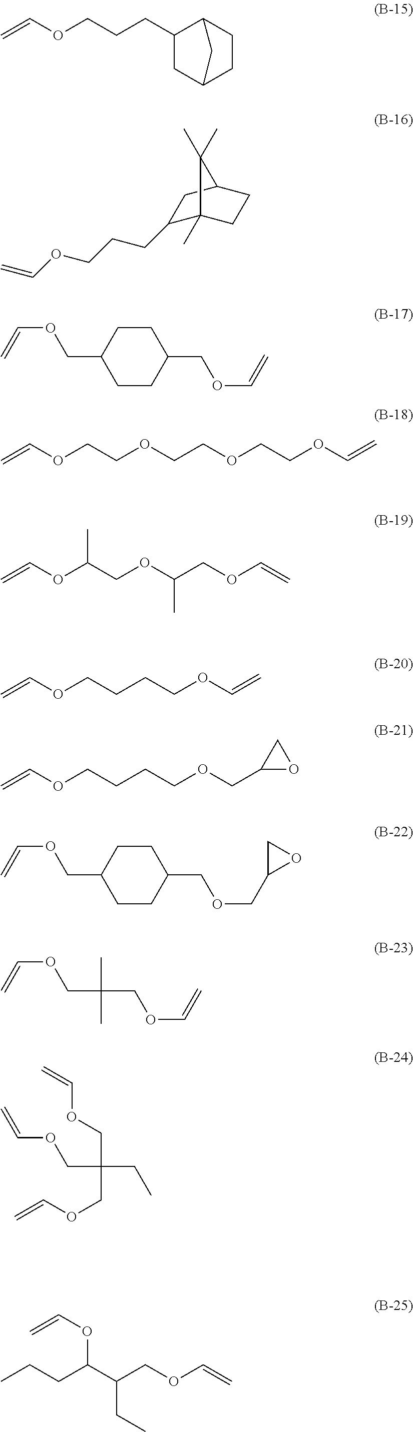

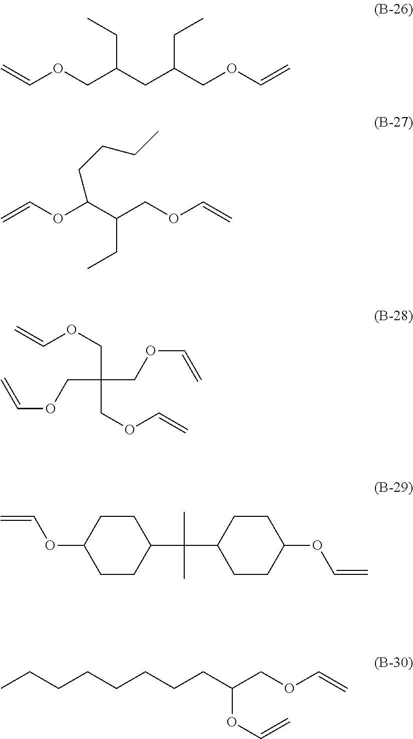

Among the above structures, 5,6-dihydrodicyclopentadienevinyl ether (B-8), tricyclo[5.2.1.0²′⁶]decane vinyl ether (B-10), cyclohexanedimethanol divinyl ether (B-17), neopentyl glycol divinyl ether (B-23), trimethylolpropane trivinyl ether (B-24), 2-ethyl-1,3-hexanediol divinyl ether (B-25), 2,4-diethyl-1,5-pentanediol divinyl ether (B-26), 2-butyl-2-ethyl-1,3-propanediol divinyl ether (B-27), pentaerythritoltetravinyl ether (B-28), 2,2-bis(4-hydroxycyclohexyl)propane divinyl ether (B-29) or 1,2-decane diol divinyl ether (B-30) can be adopted because of easily providing an ultraviolet curable liquid composition having high resistivity, low viscosity and high sensitivity. In particular, 5,6-dihydrodicyclopentadienevinyl ether (B-8), tricyclo[5.2.1.0²′⁶]decane vinyl ether (B-10), cyclohexanedimethanol divinyl ether (B-17) or 2,2-bis(4-hydroxycyclohexyl)propane divinyl ether (B-29) can be contained in the ultraviolet curable liquid composition in order to enhance sensitivity and strength after curing.

The ultraviolet curable liquid composition of the present invention can contain the following additive(s), if necessary.

<Cationic Polymerization Inhibitor>

A cationic polymerization inhibitor can also be added to the ultraviolet curable liquid composition of the present invention. Examples of the cationic polymerization inhibitor include an alkali metal compound and/or an alkali earth metal compound, and amines.

Such amines can be alkanolamines, N,N-dimethylalkylamines, N,N-dimethylalkenylamines, N,N-dimethylalkynylamines or the like. Examples include triethanolamine, triisopropanolamine, tributanolamine, N-ethyldiethanolamine, propanolamine, n-butylamine, sec-butylamine, 2-aminoethanol, 2-methylaminoethanol, 3-methylamino-1-propanol, 3-methylamino-1,2-propanediol, 2-ethylaminoethanol, 4-ethylamino-1-butanol, 4-(n-butylamino)-1-butanol, 2-(t-butylamino)ethanol, N,N-dimethylundecanol, N,N-dimethyldodecanolamine, N,N-dimethyltridecanolamine, N,N-dimethyltetradecanolamine, N,N-dimethylpentadecanolamine, N,N-dimethylnonadecylamine, N,N-dimethylicosylamine, N,N-dimethyleicosylamine, N,N-dimethylhenicosylamine, N,N-dimethyldocosylamine, N,N-dimethyltricosylamine, N,N-dimethyltetracosylamine, N,N-dimethylpentacosylamine, N,N-dimethylpentanolamine, N,N-dimethylhexanolamine, N,N-dimethylheptanolamine, N,N-dimethyloctanolamine, N,N-dimethylnonanolamine, N,N-dimethyldecanolamine, N,N-dimethylnonylamine, N,N-dimethyldecylamine, N,N-dimethylundecylamine, N,N-dimethyldodecylamine, N,N-dimethyltridecylamine, N,N-dimethyltetradecylamine, N,N-dimethylpentadecylamine, N,N-dimethylhexadecylamine, N,N-dimethylheptadecylamine and N,N-dimethyloctadecylamine. Besides such amines, a quaternary ammonium salt or the like can also be used. The cationic polymerization inhibitor can be a secondary amine.

The amount of the cationic polymerization inhibitor to be added can be 10 to 5000 ppm based on the ultraviolet curable liquid composition of the present invention.

<Radical Polymerization Inhibitor>

A radical polymerization inhibitor may also be added to the ultraviolet curable liquid composition of the present invention.

In an ultraviolet curable liquid composition containing the vinyl ether compound, the photopolymerization initiator may be slightly decomposed during storage over time to form a radical compound, and the radical compound may cause polymerization. When such radical polymerization during storage over time is supposed to be caused, the radical polymerization inhibitor can be added in order to prevent such radical polymerization. Examples of the radical polymerization inhibitor that can be applied include a phenolic hydroxyl group-containing compound, quinones such as methoquinone (hydroquinone monomethyl ether), hydroquinone and 4-methoxy-1-naphthol, a hindered amine type antioxidant, 1,1-diphenyl-2-picrylhydrazyl free radical, an N-oxyl free radical compound, a nitrogen-containing heterocyclic mercapto type compound, a thioether type antioxidant, a hindered phenol type antioxidant, ascorbic acids, zinc sulfate, thiocyanates, a thiourea derivative, various saccharides, a phosphoric acid type antioxidant, nitrites, sulfites, thiosulfates, a hydroxylamine derivative, aromatic amines, phenylenediamines, imines, sulfonamides, a urea derivative, oximes, a polycondensate of dicyandiamide and polyalkylenepolyamine, a sulfur-containing compound such as phenothiazine, a tetra azaannulene (TAA)-based complexing agent, and hindered amines.

From the viewpoint of preventing the viscosity of the ultraviolet curable liquid composition from being increased due to polymerization of the vinyl ether compound, phenols, N-oxyl free radical compounds, 1,1-diphenyl-2-picrylhydrazyl free radical, phenothiazine, quinones and hindered amines are preferable, and N-oxyl free radical compounds are particularly preferable. The amount of the radical polymerization inhibitor to be added can be 1 to 5000 ppm based on the ultraviolet curable liquid composition of the present invention.

<Pigment>

When the ultraviolet curable liquid composition of the present invention is applied to an inkjet ink, a wet electrophotographic liquid developer or the like, a pigment as a coloring material can be contained. As the pigment, any pigment can be adopted without particular limitation as long as such a pigment is adapted to the intended applications of the ultraviolet curable liquid composition of the present invention. For example, at least one selected from the group consisting of generally commercially available organic pigment and inorganic pigment, one obtained by dispersing a pigment in an insoluble resin as a dispersion medium or one obtained by grafting the surface of a pigment by a resin can be used. Examples of such a pigment include pigments described in “Dictionary of Pigments” edited by Seijiro ITO (2000), W. Herbst, K. Hunger “Industrial Organic Pigments”, Japanese Patent Application Laid-Open No. 2002-12607, Japanese Patent Application Laid-Open No. 2002-188025, Japanese Patent Application Laid-Open No. 2003-26978 and Japanese Patent Application Laid-Open No. 2003-342503.

Among the organic pigment and inorganic pigment that can be used in the present invention, examples of a pigment exhibiting a yellow color include the following:
C.I. Pigment Yellows 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C.I. Vat Yellows 1, 3 and 20.

Examples of a pigment exhibiting a red or magenta color include the following:
C.I. Pigment Reds 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3,48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238 and 269; C.I. Pigment Violet 19; and C.I. Vat Reds 1, 2, 10, 13, 15, 23, 29 and 35.

Examples of a pigment exhibiting a blue or cyan color include the following:
C.I. Pigment Blues 2, 3, 15:2, 15:3, 15:4, 16 and 17; C.I. Vat Blue 6; C.I. Acid Blue 45, and Copper Phthalocyanine pigments having 1 to 5 phthalimidemethyl groups as substituent(s) on the phthalocyanine backbone.

Examples of a pigment exhibiting a green color include the following:
C.I. Pigment Greens 7, 8 and 36. Examples of a pigment exhibiting an orange color include the following:
C.I. Pigment Oranges 66 and 51.

Examples of a black color pigment include the following:
carbon black, titanium black and aniline black. Examples of a white pigment include the following: basic lead carbonate, zinc oxide, titanium oxide and strontium titanate.

Titanium oxide here is smaller in specific gravity, higher in refractive index, and chemically and physically more stable than other white pigments, and therefore has large hiding power and coloring power as a pigment and furthermore is also excellent in resistances against an acid and an alkali, and other environments. Accordingly, titanium oxide can be utilized as the white pigment. Of course, other white pigment (which may be a pigment other than the white pigments recited.) may also be used, if necessary.

In dispersing of the pigment, a dispersing apparatus such as a ball mill, a sand mill, an attritor, a roll mill, a jet mill, a homogenizer, a paint shaker, a kneader, an agitator, a Henschel mixer, a colloid mill, an ultrasonic homogenizer, a pearl mill or a wet jell mill can be used.

A dispersant can also be added in dispersing of the pigment. Examples of the dispersant include a hydroxyl group-containing carboxylic acid ester, a salt of a long chain polyaminoamide and a high molecular acid ester, a salt of a high molecular polycarboxylic acid, a high molecular unsaturated acid ester, a high molecular copolymerized product, a modified polyacrylate, an aliphatic polyvalent carboxylic acid, a formalin condensate of naphthalenesulfonic acid, a polyoxyethylene alkyl phosphoric acid ester, and a pigment derivative. In addition, a commercially available polymeric dispersant such as Solsperse Series produced by Lubrizol Corporation can also be used.

In addition, a synergist according to various pigments can also be used as a dispersion auxiliary material. The dispersant and the dispersion auxiliary material can be added in an amount of 1 to 50 parts by mass based on 100 parts by mass of the pigment.

The pigment can be used in the form of a dispersion thereof dispersed in a liquid medium, for preparing an ultraviolet curing ink or a liquid developer using the ultraviolet curing liquid composition. As the liquid medium for preparation of such a pigment dispersion, any medium can be selected from various liquid materials and used depending on the objects as long as the intended functions in the ultraviolet curing ink and the liquid developer are not impaired. In particular, the vinyl ether compound that can also be used as the liquid monomer can be used as the liquid medium for dispersing of the pigment because the vinyl ether compound can be utilized as a monomer component as it is.

<Toner Particle>

When the ultraviolet curable liquid composition of the present invention is applied to a wet electrophotographic liquid developer, an electrostatic inkjet ink or the like, a toner particle insoluble in the liquid monomer can be contained as a coloring material. A charged particle insoluble in the liquid monomer for use in the field, such as an electrophoretic fine particle, can be contained in the electrostatic inkjet ink, and the toner particle insoluble in the liquid monomer can also be utilized as a charged particle as a coloring material. The toner particle contains a binder resin and a pigment, and can contain a charge director, if necessary.

Examples of the method for producing the toner particle include a coacervation method and a wet crushing method.

The coacervation method is described in detail in, for example, Japanese Patent Application Laid-Open No. 2003-241439 and International Re-Publication (WO 2009/041634, WO 2007/000974 and WO 2007/000975). In addition, the wet crushing method is described in detail in, for example, International Re-Publication (WO 2006/126566 and WO 2007/108485).

The toner particle obtained by such a method preferably has an average particle size of 0.05 to 5 μm, more preferably 0.05 to 1 μm, from the viewpoint that a highly fine image is obtained.

The toner particle can be used in the form of a dispersion including a pigment dispersed in a liquid medium, for preparing a liquid developer using the ultraviolet curing liquid composition. As the liquid medium for preparation of such a toner particle dispersion, any medium can be selected from various liquid materials and used depending on the objects as long as the intended functions in the ultraviolet curing liquid developer are not impaired. In particular, the vinyl ether compound that can also be utilized as the liquid monomer can be used as the liquid medium for dispersing of the toner particle because the vinyl ether compound can be utilized as a monomer component as it is.

<Binder Resin>

As the binder resin, any of various binder resins having fixability to an adherend such as paper or a plastic film can be used, a resin such as an epoxy resin, an ester resin, an acrylic resin, a styrene-acrylic resin, an alkyd resin, a polyethylene resin, an ethylene-acrylic resin or a rosin-modified resin can be used, and such a resin can be used singly or in combinations of two or more, if necessary. The content of the binder resin can be 50 to 1000 parts by mass based on 100 parts by mass of the pigment.

<Charge Director>

Various agents can be used as the charge director. Examples include oils and fats such as a linseed oil and a soybean oil; an alkyd resin, a halogen polymer, an aromatic polycarboxylic acid, an acidic group-containing water-soluble dye, an oxidation condensate of an aromatic polyamine, metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate and cobalt 2-ethylhexanoate; sulfonic acid metal salts such as a petroleum-based sulfonic acid metal salt and a metal salt of a sulfosuccinic acid ester; phospholipids such as lecithin; salicylic acid metal salts such as a t-butylsalicylic acid metal complex; and a polyvinylpyrrolidone resin, a polyamide resin, a sulfonic acid-containing resin and a hydroxybenzoic acid derivative.

<Other Additives>

Various additives other than the above can be appropriately selected and used in the ultraviolet curable liquid composition of the present invention, if necessary, depending on objects such as an enhancement in adaptivity to a recording medium, storage stability, image storing property and other various performances. Examples of the additives include a surfactant, a lubricant, a filler, a defoamer, an ultraviolet absorber, an antioxidant, a discoloration inhibitor, an antifungal agent and an antirust agent.

<Physical Properties>

When the ultraviolet curable liquid composition of the present invention is applied to a wet electrophotographic liquid developer, an electrostatic inkjet ink or the like, the developer and the ink can be prepared and used so as to have the same physical properties as physical properties of common liquid developer and electrostatic inkjet ink.

When the ultraviolet curable liquid composition of the present invention is applied to a wet electrophotographic liquid developer, the viscosity can be 0.5 to 10 mPa·s at 25° C. and the volume resistivity can be 1×10¹⁰ to 1×10¹³ Ωcm when the concentration of the toner particle included in the liquid developer is 2% by mass. A too high viscosity may reduce the electrophoretic velocity of the toner particle in the liquid developer, resulting in a reduction in printing rate. A too low volume resistivity may easily drop the potential of an electrostatic latent image, imparting a high optical density hardly or causing image blurring. A too high volume resistivity may reduce the electrophoretic velocity of the toner particle, resulting in a reduction in printing rate.

When the ultraviolet curable liquid composition of the present invention is applied to a wet electrophotographic liquid developer, an ultraviolet curing liquid developer that achieves high ultraviolet curability and that satisfies the above values of physical properties can be prepared.

<Applications>

The ultraviolet curable liquid composition of the present invention can be used in an ultraviolet curing inkjet ink, an ultraviolet curing wet electrophotographic liquid developer and an ultraviolet curing electrostatic inkjet ink, and can also be used in other applications.

Examples of an application in which a substrate is coated with the ultraviolet curable liquid composition of the present invention and the surface thereof is subjected to photocuring with being left to be opened include various applications described below: a paint for automobiles, woodwork coating, polyvinyl chloride (PVC) floor coating, ceramic wall coating, coating for building materials, resin hard coat, metallized base coat, film coating, coating for liquid crystal displays (LCDs), coating for plasma displays (PDPs), coating for optical disks, metal coating, optical fiber coating, a printing ink, a planographic ink, a metal can ink, a screen printing ink and gravure varnish.

Such usage can also be adopted in the fields of a resist, a display, a seal agent, a dental material, a photo forming material and the like.

Examples of an application in which a substrate is coated with the ultraviolet curable liquid composition of the present invention and the surface thereof is bonded with other substrate and subjected to photocuring include an adhesive, a pressure sensitive adhesive, a tackifier and a sealing agent. Furthermore, the ultraviolet curable liquid composition can be appropriately used in applications illustrated in the following literatures.
“Latest Trend III of Photosensitive Material for Electronic Components-Development Status in Semiconductor, Electronic Substrate and Display Fields-” (S. B. Research Co., Ltd., July 2006)
“Latest Trend of UV/EB Curing Technique” (RadTech Japan, March 2006)
“Applied Optical Technology/Material Dictionary” (edited by Tsuguo YAMAOKA, April 2006)
“Photocuring Technology” (Technical Information Institute Co., Ltd., March 2000)
“Photocurable Materials-Production Technology and Application Development-” (Toray Research Center, Inc., September 2007).

<Ultraviolet Light Source>

As an ultraviolet light source for curing the ultraviolet curable liquid composition of the present invention, for example, a mercury lamp, a metal halide lamp, an excimer laser, an ultraviolet laser, a cold cathode tube, a hot cathode tube, a black light or an LED (light emitting diode) can be applied. When the ultraviolet curable liquid composition is applied to an inkjet ink, a wet electrophotographic liquid developer, an electrostatic inkjet ink or the like, the ultraviolet curable liquid composition can be irradiated with ultraviolet ray after ink impact or transfer to a recording medium such as paper or a film. In irradiation with ultraviolet ray, a band metal halide lamp, a cold cathode tube, a hot cathode tube, a mercury lamp, a black light, an LED or the like can be used. The amount of irradiation with ultraviolet ray can be 0.1 to 1000 mJ/cm².

### EXAMPLES

Hereinafter, the method for producing the ultraviolet curing liquid composition of the present invention is more specifically described with reference to Examples, but the present invention is not limited thereto without departing from the gist and the scope of application thereof. Herein, “part(s)” and “%” mean “part(s) by mass” and “% by mass”, respectively, in the following description unless particularly noted. Respective materials used in Examples and Comparative Examples below are described.

### Example 1

The following respective components were mixed and dissolved to provide an ultraviolet curable liquid composition.
Cyclohexanedimethanol (exemplary compound B-17) as cationically polymerizable liquid monomer: 97.8 parts
Exemplary compound A-3 recited above as photopolymerization initiator: 0.2 parts
9,10-Bis(n-propoxy)anthracene as photopolymerization sensitizer: 1.0 part
1,2,3-Trimethoxybenzene: 1.0 part

### Examples 2 to 25 and Comparative Examples 1 to 8

The cationically polymerizable liquid monomer, the photopolymerization initiator and the photopolymerization sensitizer used in Example 1 were changed so that each composition shown in Table 1, Table 2 and Table 3 was achieved, to provide an ultraviolet curable liquid composition in each of Example 2 to 25 and Comparative Examples 1 to 8. Herein, “B-10”, “B-17” and “B-19” as monomers in Tables 1 to 3 denoted the respective exemplary compound numbers of the vinyl ether compounds recited above. Polymerization initiators used in Comparative Examples were as follows.
Photopolymerization initiator (D-1): CPI-11OP (triarylsulfonium salt type photocationic polymerization initiator produced by San-Apro Ltd.)
Photopolymerization initiator (D-2): WPI-113 (diphenyliodonium salt type photocationic polymerization initiator produced by Wako Pure Chemical Industries, Ltd.)

<Performance Evaluation>

### (Sensitivity)

A polyethylene terephthalate film was coated with each ultraviolet curable liquid composition at 25° C. by a wire bar (No. 3), and irradiated with ultraviolet ray by a high pressure mercury lamp with a lamp output of 120 mW/cm² at a predetermined amount of light to form a film (cured film). The thickness of the film formed was 6 μm. The surface of the film immediately after curing was touched by fingers, and the presence of the surface tackiness (stickiness) was confirmed and rated according to the following criteria.
Rank “5”: Tackiness was not observed in curing at an amount of light of 45 mJ/cm².
Rank “4”: Tackiness was observed in curing at an amount of light of 45 mJ/cm², and tackiness was not observed in curing at an amount of light of 150 mJ/cm².
Rank “3”: Tackiness was observed in curing at an amount of light of 150 mJ/cm², and tackiness was not observed in curing at an amount of light of 300 mJ/cm².
Rank “2”: Tackiness was observed in curing at an amount of light of 300 mJ/cm², and tackiness was not observed in curing at an amount of light of 1000 mJ/cm².
Rank “1”: Tackiness was observed even in curing at an amount of light of 1000 mJ/cm².

(Volume Resistivity)

The volume resistivity was measured using R8340 manufactured by Advantest Corporation.

(Storage Property)

A light shielding bottle was charged with each ultraviolet curable liquid composition and tightly sealed under a storage environment of 25° C./50% RH, and the change in viscosity before and after storage was calculated as the ratio of viscosity after storage/viscosity before storage and rated according to the following criteria.
Rank “5”: The change in viscosity was 1.1 or less even after storage for 1 year, and the change in viscosity was not almost observed.
Rank “4”: The change in viscosity was 1.1 or less after storage for 6 months, and the change in viscosity was 1.1 or more after storage for 1 year.
Rank “3”: The change in viscosity was 1.1 or less after storage for 3 months, and the change in viscosity was 1.1 or more after storage for 6 months.
Rank “2”: The change in viscosity was 1.1 or more after storage for 3 months.
Rank “1”: Solidification was observed after storage for 3 months, and the viscosity could not be measured.

TABLE 1

| | | Example 1 | Example 2 | Example 3 | Example 4 | Example 5 | Example 6 |
|---|---|---|---|---|---|---|---|
| Monomer | B - 8 | | | | | | |
| | B - 10 | | | | | | |
| | B - 17 | 97.8 | 97.8 | 97.8 | 97.8 | 97.8 | 97.8 |
| | B - 19 | | | | | | |
| Initiator | A - 3 | 0.2 | 0.2 | 0.2 | 0.2 | 0.2 | 0.2 |
| | A - 12 | | | | | | |
| | A - 26 | | | | | | |
| | D - 1 | | | | | | |
| | D - 2 | | | | | | |
| Photosensitizer | 2,4-Diethylthioxanthone | | | | | | |
| | 2-Isopropylthioxanthone | | | | | | |
| | 9,10-Bis(n-propoxy)anthracene | 1 | 1 | 1 | 1 | 1 | 1 |
| | 9,10-Bis(n-butoxy)anthracene | | | | | | |
| | 1,4-Diethoxynaphthalene | | | | | | |
| | 2-Chloro-1,4-bis(n-propoxy)naphthalene | | | | | | |
| | 2-Methyl-1,4-bis(n-butoxy)naphthalene | | | | | | |
| | 2,6-Diethoxynaphthalene | | | | | | |
| | 1-n-Propoxynaphthalene | | | | | | |
| | 1,2,6-Trimethoxynaphthalene | | | | | | 1 |
| | 1,4-Diethoxybenzene | | | | | 1 | |
| | 2-Chloro-1,4-diethoxybenzene | | | | 1 | | |
| | 1,2-Dimethoxybenzene | | | 1 | | | |
| | n-Butoxybenzene | | 1 | | | | |
| | 1,2,3-Trimethoxybenzene | 1 | | | | | |
| Inhibitor | Tributylamine | | | | | | |
| | N,N-DICYCLOHEXYLMETHYLAMINE | | | | | | |
| Rating | Sensitivity | 4 | 4 | 4 | 4 | 4 | 4 |
| | Viscosity (mPa · s) | 4.6 | 4.6 | 4.6 | 4.6 | 4.6 | 4.6 |
| | Volume resistivity (Ωcm) | 1.8E+10 | 6.1E+10 | 4.1E+10 | 3.3E+10 | 4.4E+10 | 5.2E+10 |
| | Storage stability | 3 | 3 | 3 | 4 | 4 | 5 |

| | | Example 7 | Example 8 | Example 9 | Example 10 | Example 11 |
|---|---|---|---|---|---|---|
| Monomer | B - 8 | | | | | |
| | B - 10 | | | | | |
| | B - 17 | 97.8 | 97.8 | 97.8 | 97.8 | 97.8 |
| | B - 19 | | | | | |
| Initiator | A - 3 | 0.2 | 0.2 | 0.2 | 0.2 | 0.2 |
| | A - 12 | | | | | |
| | A - 26 | | | | | |
| | D - 1 | | | | | |
| | D - 2 | | | | | |
| Photosen- | 2,4-Diethylthioxanthone | | | | | |
| sitizer | 2-Isopropylthioxanthone | | | | | |
| | 9,10-Bis(n-propoxy)anthracene | 1 | 1 | 1 | 1 | 1 |
| | 9,10-Bis(n-butoxy)anthracene | | | | | |
| | 1,4-Diethoxynaphthalene | | | | | 1 |
| | 2-Chloro-1,4-bis(n-propoxy)naphthalene | | | | 1 | |
| | 2-Methyl-1,4-bis(n-butoxy)naphthalene | | | 1 | | |
| | 2,6-Diethoxynaphthalene | | 1 | | | |
| | 1-n-Propoxynaphthalene | 1 | | | | |
| | 1,2,6-Trimethoxynaphthalene | | | | | |
| | 1,4-Diethoxybenzene | | | | | |
| | 2-Chloro-1,4-diethoxybenzene | | | | | |
| | 1,2-Dimethoxybenzene | | | | | |
| | n-Butoxybenzene | | | | | |
| | 1,2,3-Trimethoxybenzene | | | | | |
| Inhibitor | Tributylamine | | | | | |
| | N,N-DICYCLOHEXYLMETHYLAMINE | | | | | |
| Rating | Sensitivity | 4 | 4 | 5 | 5 | 5 |
| | Viscosity (mPa · s) | 4.6 | 4.6 | 4.6 | 4.6 | 4.6 |
| | Volume resistivity (Ωcm) | 7.1E+10 | 8.5E+10 | 8.9E+10 | 7.3E+10 | 8.6E+10 |
| | Storage stability | 5 | 5 | 5 | 5 | 5 |

TABLE 2

| | | Example 12 | Example 13 | Example 14 | Example 15 | Example 16 | Example 17 |
|---|---|---|---|---|---|---|---|
| Monomer | B - 8 | | | | | | |
| | B - 10 | | | | | | |
| | B - 17 | 97.8 | 97.8 | 97.8 | 98.7 | 98.3 | 98.7 |
| | B - 19 | | | | | | |
| Initiator | A - 3 | 0.2 | 0.2 | 0.2 | 0.2 | 0.2 | 0.2 |
| | A - 12 | | | | | | |
| | A - 26 | | | | | | |
| | D - 1 | | | | | | |
| | D - 2 | | | | | | |
| Photosensitizer | 2,4-Diethylthioxanthone | | 1 | | 1 | 1 | 0.1 |
| | 2-Isopropylthioxanthone | | | 1 | | | |
| | 9,10-Bis(n-propoxy)anthracene | | | | | | |
| | 9,10-Bis(n-butoxy)anthracene | 1 | | | | | |
| | 1,4-Diethoxynaphthalene | 1 | 1 | 1 | 0.1 | 0.5 | 1 |
| | 2-Chloro-1,4-bis(n-propoxy)naphthalene | | | | | | |
| | 2-Methyl-1,4-bis(n-butoxy)naphthalene | | | | | | |
| | 2,6-Diethoxynaphthalene | | | | | | |
| | 1-n-Propoxynaphthalene | | | | | | |
| | 1,2,6-Trimethoxynaphthalene | | | | | | |
| | 1,4-Diethoxybenzene | | | | | | |
| | 2-Chloro-1,4-diethoxybenzene | | | | | | |
| | 1,2-Dimethoxybenzene | | | | | | |
| | n-Butoxybenzene | | | | | | |
| | 1,2,3-Trimethoxybenzene | | | | | | |
| Inhibitor | Tributylamine | | | | | | |
| | N,N-DICYCLOHEXYLMETHYLAMINE | | | | | | |
| Rating | Sensitivity | 5 | 5 | 5 | 4 | 4 | 3 |
| | Viscosity (mPa · s) | 4.6 | 4.6 | 4.6 | 4.5 | 4.6 | 4.5 |
| | Volume resistivity (Ωcm) | 8.8E+10 | 2.5E+11 | 2.7E+11 | 2.9E+11 | 2.7E+11 | 4.5E+11 |
| | Storage stability | 5 | 5 | 5 | 3 | 4 | 5 |

| | | Example 18 | Example 19 | Example 20 | Example 21 | Example 22 |
|---|---|---|---|---|---|---|
| Monomer | B - 8 | | | | 97.8 | |
| | B - 10 | | | | | 97.8 |
| | B - 17 | 98.3 | 96.8 | 98.0 | | |
| | B - 19 | | | | | |
| Initiator | A - 3 | 0.2 | 1.2 | 0.04 | 0.2 | 0.2 |
| | A - 12 | | | | | |
| | A - 26 | | | | | |
| | D - 1 | | | | | |
| | D - 2 | | | | | |
| Photosensitizer | 2,4-Diethylthioxanthone | 0.5 | 1 | 1 | 1 | 1 |
| | 2-Isopropylthioxanthone | | | | | |
| | 9,10-Bis(n-propoxy)anthracene | | | | | |
| | 9,10-Bis(n-butoxy)anthracene | | | | | |
| | 1,4-Diethoxynaphthalene | 1 | 1 | 1 | 1 | 1 |
| | 2-Chloro-1,4-bis(n-propoxy)naphthalene | | | | | |
| | 2-Methyl-1,4-bis(n-butoxy)naphthalene | | | | | |
| | 2,6-Diethoxynaphthalene | | | | | |
| | 1-n-Propoxynaphthalene | | | | | |
| | 1,2,6-Trimethoxynaphthalene | | | | | |
| | 1,4-Diethoxybenzene | | | | | |
| | 2-Chloro-1,4-diethoxybenzene | | | | | |
| | 1,2-Dimethoxybenzene | | | | | |
| | n-Butoxybenzene | | | | | |
| | 1,2,3-Trimethoxybenzene | | | | | |
| Inhibitor | Tributylamine | | | | | |
| | N,N-DICYCLOHEXYLMETHYLAMINE | | | | | |
| Rating | Sensitivity | 4 | 5 | 3 | 5 | 5 |
| | Viscosity (mPa · s) | 4.6 | 4.7 | 4.6 | 4.6 | 4.6 |
| | Volume resistivity (Ωcm) | 3.6E+11 | 5.6E+10 | 4.4E+11 | 2.1E+11 | 7.2E+10 |
| | Storage stability | 5 | 3 | 5 | 5 | 5 |

TABLE 3

| | | Example | Example | Example | Comparative | Comparative | Comparative |
|---|---|---|---|---|---|---|---|
| | | 23 | 24 | 25 | Example 1 | Example 2 | Example 3 |
| Monomer | B - 8 | | | | | | |
| | B - 10 | | | | | | |
| | B - 17 | | 97.8 | 97.8 | 98.8 | 98.7 | 98.8 |
| | B - 19 | 97.8 | | | | | |
| Initiator | A - 3 | 0.2 | | | 0.2 | 0.2 | 0.2 |
| | A - 12 | | 0.2 | | | | |
| | A - 26 | | | 0.2 | | | |
| | D - 1 | | | | | | |
| | D - 2 | | | | | | |
| Photosensitizer | 2,4-Diethylthioxanthone | 1 | 1 | 1 | 1 | 1 | 1 |
| | 2-Isopropylthioxanthone | | | | | | |
| | 9,10-Bis(n-propoxy)anthracene | | | | | | |
| | 9,10-Bis(n-butoxy)anthracene | | | | | | |
| | 1,4-Diethoxynaphthalene | 1 | 1 | 1 | | | |
| | 2-Chloro-1,4-bis(n-propoxy)naphthalene | | | | | | |
| | 2-Methyl-1,4-bis(n-butoxy)naphthalene | | | | | | |
| | 2,6-Diethoxynaphthalene | | | | | | |
| | 1-n-Propoxynaphthalene | | | | | | |
| | 1,2,6-Trimethoxynaphthalene | | | | | | |
| | 1,4-Diethoxybenzene | | | | | | |
| | 2-Chloro-1,4-diethoxybenzene | | | | | | |
| | 1,2-Dimethoxybenzene | | | | | | |
| | n-Butoxybenzene | | | | | | |
| | 1,2,3-Trimethoxybenzene | | | | | | |
| Inhibitor | Tributylamine | | | | 0.01 | 0.1 | |
| | N,N-DICYCLOHEXYLMETHYLAMINE | | | | | | 0.01 |
| Rating | Sensitivity | 4 | 5 | 5 | 4 | 1 | 4 |
| | Viscosity (mPa · s) | 1.1 | 4.6 | 4.6 | 4.5 | 4.5 | 4.5 |
| | Volume resistivity (Ωcm) | 3.1E+10 | 1.2E+11 | 4.5E+11 | 3.5E+11 | 1.5E+11 | 1.2E+11 |
| | Storage stability | 5 | 5 | 5 | 1 | 5 | 1 |

| | | Comparative | Comparative | Comparative | Comparative | Comparative |
|---|---|---|---|---|---|---|
| | | Example 4 | Example 5 | Example 6 | Example 7 | Example 8 |
| Monomer | B - 8 | | | | | |
| | B - 10 | | | | | |
| | B - 17 | 98.7 | 97.8 | 97.0 | 97.8 | 97.0 |
| | B - 19 | | | | | |
| Initiator | A - 3 | 0.2 | | | | |
| | A - 12 | | | | | |
| | A - 26 | | | | | |
| | D - 1 | | 0.2 | 1 | | |
| | D - 2 | | | | 0.2 | 1 |
| Photosensitizer | 2,4-Diethylthioxanthone | 1 | 1 | 1 | 1 | 1 |
| | 2-Isopropylthioxanthone | | | | | |
| | 9,10-Bis(n-propoxy)anthracene | | | | | |
| | 9,10-Bis(n-butoxy)anthracene | | | | | |
| | 1,4-Diethoxynaphthalene | | 1 | 1 | 1 | 1 |
| | 2-Chloro-1,4-bis(n-propoxy)naphthalene | | | | | |
| | 2-Methyl-1,4-bis(n-butoxy)naphthalene | | | | | |
| | 2,6-Diethoxynaphthalene | | | | | |
| | 1-n-Propoxynaphthalene | | | | | |
| | 1,2,6-Trimethoxynaphthalene | | | | | |
| | 1,4-Diethoxybenzene | | | | | |
| | 2-Chloro-1,4-diethoxybenzene | | | | | |
| | 1,2-Dimethoxybenzene | | | | | |
| | n-Butoxybenzene | | | | | |
| | 1,2,3-Trimethoxybenzene | | | | | |
| Inhibitor | Tributylamine | | | | | |
| | N,N-DICYCLOHEXYLMETHYLAMINE | 0.1 | | | | |
| Rating | Sensitivity | 2 | 1 | 5 | 1 | 5 |
| | Viscosity (mPa · s) | 4.5 | 4.5 | 4.6 | 4.5 | 4.6 |
| | Volume resistivity (Ωcm) | 9.2E+10 | 5.2E+7 | 5.0E+7 | 5.6E+7 | 5.5E+7 |
| | Storage stability | 5 | 3 | 1 | 3 | 1 |

“E” of the value of each volume resistivity in Tables 1 to 3 means “x10”, and the number at the right of “E” means exponent. For example, “1.8E +10” in Example 1 means “1.8×10¹⁰”.

It was found from the rating results in Comparative Examples 1 to 4 that, in the prior art in which the basic compound was added for an improvement in storage stability, the basic compound inhibited the function of an acid generated by exposure and thus storage stability and sensitivity were difficult to simultaneously be satisfied.

On the contrary, it was found from the rating results in Examples 1 to 25 that the ultraviolet curable liquid composition of the present invention could allow excellent storage stability and sensitivity to be simultaneously satisfied.

It was found that the ultraviolet curable liquid compositions prepared in Comparative Examples 5 to 8 that the photopolymerization initiator in the compositions were changed from the photopolymerization initiator in the ultraviolet curable liquid composition of the present invention, had difficulty in simultaneously satisfying storage stability and sensitivity and also had a significantly reduced volume resistivity.

### Example 26

(Preparation of ink)

The following respective components were loaded in a planetary bead mill (Classic Line P-6/Fritsch) together with zirconia beads having a diameter of 0.5 mm, and mixed and dispersed at room temperature at 200 rpm for 4 hours to provide a pigment dispersion.
Pigment Blue 15:3 as pigment: 20 parts
Solsperse 24000GR produced by Lubrizol Corporation as dispersant of pigment: 7 parts
Dodecylvinyl ether (exemplary compounds (B-3)): 73 parts

The following respective components were added to 10.0 parts of the pigment dispersion to provide an ultraviolet curing inkjet ink.
Cyclohexanedimethanol divinyl ether (exemplary compound B-17) as polymerizable liquid monomer: 87.8 parts
Compound represented as exemplary compound A-3 as photopolymerization initiator: 0.2 parts
2,4-Diethylthioxanthone as photopolymerization sensitizer: 1.0 part
1,4-Diethoxynaphthalene: 1.0 part

The resulting ultraviolet curing inkjet ink was loaded in an UV curing inkjet printer UJF-3042HG manufactured by Mimaki Engineering Co., Ltd. and subjected to evaluation of printing characteristics, and as a result, could be confirmed to have good printing characteristics.

### Example 27

### (Production of Ultraviolet Curing Liquid Developer)

A separable flask was charged with 25 parts of Nucrel N1525 (ethylene-methacrylic acid resin/produced by Du Pont-Mitsui Polychemicals) and 75 parts of dodecylvinyl ether (exemplary compound (B-3)). The resulted mixture was stirred at 200 rpm by using of a three-one motor was used while heating the mixture to 130° C. in an oil bath over 1 hour. After being held at 130° C. for 1 hour, the resultant was gradually cooled at a rate of −15° C. per hour to prepare a toner particle precursor. The resulting toner particle precursor was a white paste.

The toner particle precursor (59.40 parts) was loaded in a planetary bead mill (Classic Line P-6/Fritsch) together with the following respective components, and pulverized at room temperature at 200 rpm for 4 hours to provide a toner particle dispersion (solid content: 20% by mass).
Pigment Blue 15:3 as pigment: 4.95 parts
Aluminum tristearate as charge adjuvant: 0.2 parts
Dodecylvinyl ether (exemplary compound B-3): 35.45 parts
Zirconia beads having a diameter of 0.5 mm

The resulting toner particle had an average particle size of 0.85 _{R}m (measured by Nanotrac 150 manufactured by Nikkiso Co., Ltd.).

The following respective components were added to 10.0 parts of the toner particle dispersion to provide an ultraviolet curing liquid developer.
Hydrogenated lecithin (Lecinol S-10/produced by Nikko Chemicals Co., Ltd.) as charge director: 0.1 parts
Cyclohexanedimethanol divinyl ether (exemplary compound B-17) as polymerizable liquid monomer: 87.7 parts
Photopolymerization initiator represented as exemplary compound A-3: 0.2 parts
2,4-Diethylthioxanthone: 1.0 part and 1,4-diethoxynaphthalene: 1.0 part, as photopolymerization sensitizer

The resulting ultraviolet curing liquid developer was used to evaluate the volume resistivity, developability and fixability, as described below.

(Volume resistivity)

The volume resistivity was measured using R8340 manufactured by Advantest Corporation, and was found to be 1.3×10¹¹ Ωcm.

(Developability)

An electrostatic pattern was formed on electrostatic recording paper at a surface charge of 150 to 500 V, and the ultraviolet curing liquid developer was used to perform development by a roller developing machine. The quality of the resulting image was confirmed, and as a result, a high-density and highly-fine image was obtained. While the variation in density and image blurring were observed due to attenuation of the surface charge at a low electric resistivity of the liquid developer, the variation in density and image blurring were not observed by use of the ultraviolet curing liquid developer.

(Fixability)

A polyethylene terephthalate film was coated with the ultraviolet curing liquid developer at 25° C. by a wire bar (No. 6), and irradiated by a high pressure mercury lamp with a lamp output of 120 mW/cm² at an amount of light of 45 mJ/cm² (measurement wavelength: 365 nm) to form a cured film. The surface of the film immediately after curing was touched by fingers, and the presence of the surface tackiness (stickiness) was confirmed, but tackiness was not observed at all and it could be confirmed that sufficient fixability was achieved.

### Comparative Example 9

The following respective components were added to 10.0 parts of the toner particle dispersion produced in the same manner as in Example 27, to provide an ultraviolet curing liquid developer.
Hydrogenated lecithin (Lecinol S-10/produced by Nikko Chemicals Co., Ltd.) as charge director: 0.1 parts
Cyclohexanedimethanol divinyl ether (exemplary compound B-17) as polymerizable liquid monomer: 86.9 parts
Photopolymerization initiator represented in D-1: 1.0 part
2,4-Diethylthioxanthone: 1.0 part and 1,4-diethoxynaphthalene: 1.0 part, as photopolymerization sensitizer

The resulting ultraviolet curing liquid developer was used to evaluate the volume resistivity, developability and fixability, as described below.

(Volume Resistivity)

The volume resistivity was measured using R8340 manufactured by Advantest Corporation, and was found to be 4.9×10⁷ Qcm.

(Developability)

The same evaluation as in Example 27 was tried, but development could not be conducted. The reason for this was considered as follows: a too low volume resistivity of the liquid developer caused the surface charge to be significantly attenuated.

(Fixability)

The same evaluation as in Example 27 was performed, and tackiness was not observed at all and it could be confirmed that sufficient fixability was achieved.

### Example 28

The ultraviolet curing liquid developer prepared in Example 27 was used for an ultraviolet curing electrostatic inkjet ink. The ink was used for printing on a medium by use of an inkjet printing apparatus described in PCT Publication No. WO 93/11866 and evaluated with respect to printing characteristics, and as a result, it could be confirmed that good printing characteristics were achieved. The apparatus was operated at an operating frequency of 2.5 kHz and a maximum discharge voltage of +2400 V.

The ink solid density of the ink fixed onto the medium subjected to printing was measured by a thermal analysis apparatus, and it could be confirmed that the solid density was 18.8% and ejection was conducted after concentrating by a nozzle.

Next, the medium subjected to printing was irradiated by a high pressure mercury lamp with a lamp output of 120 mW/cm² at an amount of light of 45 mJ/cm² (measurement wavelength: 365 nm), and subjected to UV curing. The surface of the printed product immediately after curing was touched by fingers and confirmed about the presence of surface tackiness (stickiness), and tackiness was not observed at all and it could be confirmed that sufficient fixability was achieved.

### Comparative Example 10

The ultraviolet curing liquid developer prepared in Comparative Example 9 was used for an ultraviolet curing electrostatic inkjet ink. The ink was tried to be used for printing on a medium by use of an inkjet printing apparatus described in PCT Publication No. WO 93/11866, but the ink was not ejected.

### INDUSTRIAL APPLICABILITY

The ultraviolet curable liquid composition of the present invention includes at least the following respective components:
at least one vinyl ether compound as a cationically polymerizable liquid monomer;
at least one compound represented by the general formula (1) as a photopolymerization initiator; and
at least one selected from the group consisting of compounds represented by general formula (2) and general formula (3), and at least one selected from the group consisting of compounds represented by general formula (4) and general formula (5), as a photopolymerization sensitizer.

The vinyl ether compound can be combined with the combination of the specific compounds as the photopolymerization initiator and the photopolymerization sensitizer, to thereby provide an ultraviolet curing liquid composition having high sensitivity, excellent storage stability, low viscosity, and excellent fixability after ultraviolet curing. The ultraviolet curable liquid composition can be used to provide an ultraviolet curing inkjet ink, an ultraviolet curing wet electrophotographic liquid developer, an ultraviolet curing electrostatic inkjet ink or the like. The liquid developer and inks are also high in sensitivity, low in viscosity and excellent in storage stability, exhibit a high optical density and hardly causes image blurring, and has sufficient fixability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-003347, filed Jan. 9, 2015, and Japanese Patent Application No. 2015-257003, filed Dec. 28, 2015, which are hereby incorporated by reference herein their entirety.

1. An ultraviolet curable liquid composition comprising:
a cationically polymerizable liquid monomer;
a photopolymerization initiator; and
a photopolymerization sensitizer,
wherein the cationically polymerizable liquid monomer is a vinyl ether compound,
wherein the photopolymerization initiator comprises a compound represented by general formula (1), and
wherein the photopolymerization sensitizer comprises:
(A) at least one compound selected from the group consisting of a compound represented by general formula (2) and a compound represented by general formula (3); and
(B) at least one compound selected from the group consisting of a compound represented by general formula (4) and a compound represented by general formula (5): 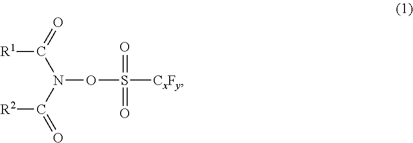
wherein, in the general formula (1), x represents an integer of 1 to 8, y represents an integer of 3 to 17, and R¹ and R² are bound to each other to form a cyclic structure; 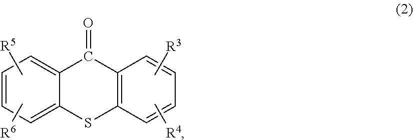
wherein, in the general formula (2), R³, R⁴, R⁵ and R⁶ each independently represents a hydrogen atom, a substituted or unsubstituted alkyl group, a substituted or unsubstituted cycloalkyl group, a substituted or unsubstituted alkoxy group, a substituted or unsubstituted aryloxy group, a cyano group, a substituted or unsubstituted aralkyl group, a substituted or unsubstituted alkoxycarbonyl group, or a halogen atom;
wherein, in the general formula (3), R⁷ and R⁸ each independently represents a hydrogen atom, an alkyl group, an aralkyl group, an alkoxy group, an aryloxy group, or a halogen atom, and R⁹ and R¹⁹ each independently represents hydrogen atom, an aralkyl group, an alkyl group having 1 to 9 carbon atoms optionally substituted with a group having an oxygen atom, or a glycidyl group; 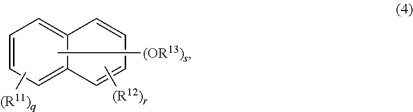
wherein, in the general formula (4), R¹¹ and R¹² each independently represents an alkyl group, an aralkyl group, an alkoxy group, an aryloxy group, or a halogen atom, q and r each independently represent an integer of 0 to 4, R¹³ represents a hydrogen atom, an alkyl group having 1 to 9 carbon atoms optionally substituted with a substituent having an oxygen atom, a glycidyl group, or an aralkyl group, s represents an integer of 1 to 3, each R¹¹ is independently selected when more than one R¹¹ is present, each R¹² is independently selected when more than one R¹² is present, and each R¹³ is independently selected when more than one R¹³ is present; and 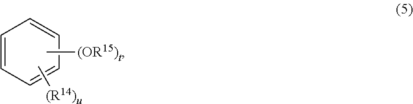
wherein, in the general formula (5), R¹⁴ represents an alkyl group, an aralkyl group, an alkoxy group, an aryloxy group or a halogen atom, u represents an integer of 0 to 4, R¹⁵ represents a hydrogen atom, an alkyl group having 1 to 9 carbon atoms optionally substituted with a substituent having an oxygen atom, a glycidyl group or an aralkyl group, t represents an integer of 1 or 2, each R¹⁴ is independently selected more than one R¹⁴ is present, and each R¹⁵ is independently selected when more than one R¹⁵ is present.

2. The ultraviolet curable liquid composition according to claim 1, wherein the compound represented by the general formula (4) is a compound represented by general formula (6): 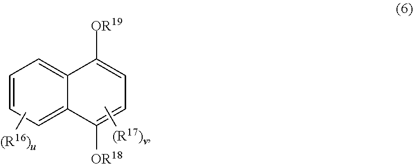
wherein, in the general formula (6), R¹⁶ and R¹⁷ each independently represents an alkyl group, an aralkyl group, an alkoxy group, an aryloxy group,. or a halogen atom, u and v each independently represent an integer of 0 to 4, R″ and R¹⁹ each independently represents a hydrogen atom, an alkyl group having 1 to 9 carbon atoms optionally substituted with a substituent having an oxygen atom, a glycidyl group or an aralkyl group, each R¹⁶ is independently selected when more than one R¹⁶ is present, and each R¹⁷ is independently selected when more than one R¹⁷ is present.

3. The ultraviolet curable liquid composition according to claim 1, wherein the compound represented by the general formula (5) is a compound represented by general formula (7): 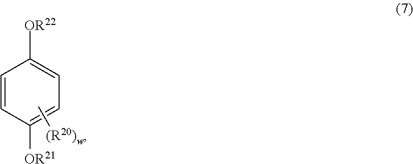
wherein, in the general formula (7), R²⁰ represents an alkyl group, an aralkyl group, an alkoxy group, an aryloxy group, or a halogen atom, w represents an integer of 0 to 4, R²¹ and R²² each independently represents a hydrogen atom, an alkyl group having 1 to 9 carbon atoms optionally substituted with a substituent having an oxygen atom, a glycidyl group or an aralkyl group, and each R²⁰ is independently selected when more than one R²⁰ is present.

4. The ultraviolet curable liquid composition according to claim 2, wherein the photopolymerization sensitizer comprises:
at least one compound selected from the group consisting of the compound represented by the general formula (2) and the compound represented by the general formula (3); and
the compound represented by the general formula (6).

5. The ultraviolet curable liquid composition according to claim 1, wherein C/A is 1.0 or more,
where a content of at least one compound selected from the group consisting of the compound represented by the general formula (4) and the compound represented by the general formula (5) is defined as C % by mass and where a content of the compound represented by the general formula (1) is defined as A % by mass.

6. The ultraviolet curable liquid composition according to claim 1, wherein a content of the photopolymerization initiator is 0.01 to 5 parts by mass based on 100 parts by mass of the cationically polymerizable liquid monomer.

7. The ultraviolet curable liquid composition according to claim 1, wherein the vinyl ether compound is a vinyl ether compound having a cyclic structure in a molecule.

8. The ultraviolet curable liquid composition according to claim 1, wherein CₓF_{y} in the general formula (1) is any of CF₃, C₂F₅, C₃F₇, and C₄F₉.

9. The ultraviolet curable liquid composition according to claim 1, wherein CₓF_{y} in the general formula (1) is C₆F₅.

10. An ultraviolet curing inkjet ink comprising:
an ultraviolet curable liquid composition; and
a pigment or a dye,
wherein the ultraviolet curable liquid composition comprises:
a cationically polymerizable liquid monomer;
a photopolymerization initiator; and
a photopolymerization sensitizer,
wherein the cationically polymerizable liquid monomer is a vinyl ether compound,
wherein the photopolymerization initiator comprises a compound represented by general formula (1), and
wherein the photopolymerization sensitizer comprises:
(A) at least one compound selected from the group consisting of a compound represented by general formula (2) and a compound represented by general formula (3); and
(B) at least one compound selected from the group consisting of a compound represented by general formula (4) and a compound represented by general formula (5): 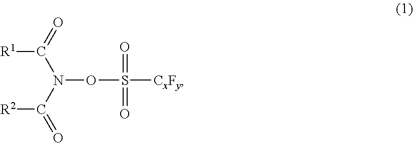
wherein, in the general formula (1), x represents an integer of 1 to 8, y represents an integer of 3 to 17, and R^{l} and R² are bound to each other to form a cyclic structure: 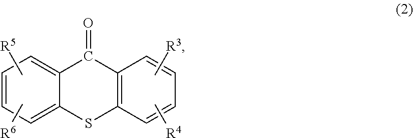
wherein, in the general formula (2), R³, R⁴, R⁵ and R⁶ each independently represents a hydrogen atom, a substituted or unsubstituted alkyl group, a substituted or unsubstituted cycloalkyl group, a substituted or unsubstituted alkoxy group, a substituted or unsubstituted aryloxy group, a cyano group, a substituted or unsubstituted aralkyl group, a substituted or unsubstituted alkoxycarbonyl group, or a halogen atom; 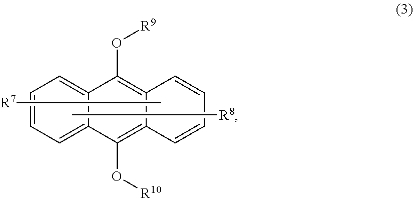
wherein, in the general formula (3), R⁷ and R⁸ each independently represents a hydrogen atom, an alkyl group, an aralkyl group, an alkoxy group, an aryloxy group, or a halogen atom, and R⁹ and R¹⁰ each independently represents a hydrogen atom, an aralkyl group, an alkyl group having 1 to 9 carbon atoms optionally substituted with a group having an oxygen atom, or a glycidyl group; 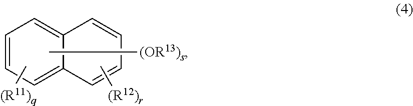
wherein, in the general formula (4), R¹¹ and R¹² each independently represents an alkyl group, an aralkyl group, an alkoxy group, an aryloxy group, or a halogen atom, q and r each independently represent an integer of 0 to 4, R¹³ represents a hydrogen atom, an alkyl group having 1 to 9 carbon atoms optionally substituted with a substituent having an oxygen atom, a glycidyl group, or an aralkyl group, s represents an integer of 1 to 3, each R¹¹ is independently selected when more than one R¹¹ is present, each R¹² is independently selected when more than one R¹² is present, and each R¹³ is independently selected when more than one R¹³ is present and 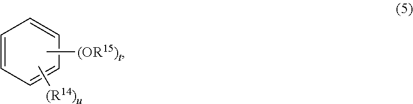
wherein, in the general formula (5), R¹⁴ represents an alkyl group, an aralkyl group, an alkoxy group, an aryloxy group or a halogen atom, u represents an integer of 0 to 4, R¹⁵ represents a hydrogen atom, an alkyl group having 1 to 9 carbon atoms optionally substituted with a substituent having an oxygen atom, a glycidyl group, or an aralkyl group, t represents an integer of 1 or 2, each R¹⁴ is independently selected when more than one R¹⁴ is present, and each R¹⁵ is independently selected when more than one R¹⁵ is present.

11. An ultraviolet curing wet electrophotographic liquid developer comprising:
an ultraviolet curable liquid composition comprising:
a cationically polymerizable liquid monomer;
a photopolymerization initiator; and
a photopolymerization sensitizer; and
a toner particle insoluble in the cationically polymerizable liquid monomer
wherein the cationically polymerizable liquid monomer is a vinyl ether compound,
wherein the photopolymerization initiator comprises a compound represented by general formula (1), and
wherein the photopolymerization sensitizer comprises:
(A) at least one compound selected from the group consisting of a compound represented by general formula (2) and a compound represented by general formula (3); and
(B) at least one compound selected from the group consisting of a compound represented by general formula (4) and a compound represented by general formula (5): 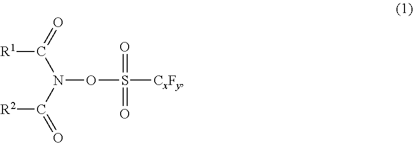
wherein, in the general formula (1), x represents an integer of 1 to 8, y represents an integer of 3 to 17, and R¹ and R² are bound to each other to form a cyclic structure: 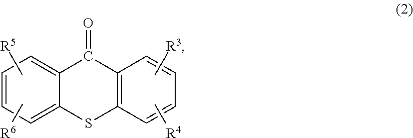
wherein, in the general formula (2), R³, R⁴, R⁵ and R⁶ each independently represents a hydrogen atom, a substituted or unsubstituted alkyl group, a substituted or unsubstituted cycloalkyl group, a substituted or unsubstituted alkoxy group, a substituted or unsubstituted aryloxy group, a cyano group, a substituted or unsubstituted aralkyl group, a substituted or unsubstituted alkoxycarbonyl group, or a halogen atom; 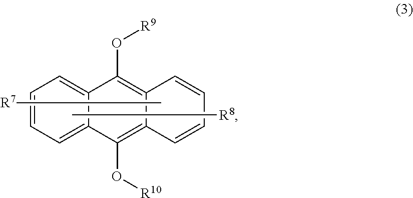
wherein, in the general formula (3), R⁷ and R⁸ each independently represents a hydrogen atom, an alkyl group, an aralkyl group, an alkoxy group, an aryloxy group, or a halogen atom, and R⁹ and R¹⁰ each independently represents a hydrogen atom, an aralkyl group, an alkyl group having 1 to 9 carbon atoms optionally substituted with a group having an oxygen atom, or a glycidyl group; 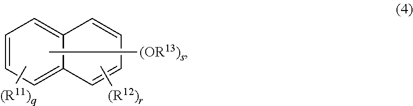
wherein, in the general formula (4), R¹¹ and R¹² each independently represents an alkyl group, an aralkyl group, an alkoxy group, an aryloxy group, or a halogen atom, q and r each independently represent an integer of 0 to 4, R¹³ represents a hydrogen atom, an alkyl group having 1 to 9 carbon atoms optionally substituted with a substituent having an oxygen atom, a glycidyl group, or an aralkyl group, s represents an integer of 1 to 3, each R¹¹ is independently selected when more than one R¹¹ is present, each R¹² is independently selected when more than one R¹² is present, and each R¹³ is independently selected when more than one R¹³ is present and 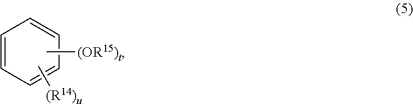
wherein, in the general formula (5), R¹⁴ represents an alkyl group, an aralkyl group, an alkoxy group, an aryloxy group or a halogen atom, u represents an integer of 0 to 4, R¹⁵ represents a hydrogen atom, an alkyl group having 1 to 9 carbon atoms optionally substituted with a substituent having an oxygen atom, a glycidyl group, or an aralkyl group, t represents an integer of 1 or 2, each R¹⁴ is independently selected when more than one R¹⁴ is present, and each R¹⁵ is independently selected when more than one R¹⁵ is present.

12. An ultraviolet curing electrostatic inkjet ink comprising:
an ultraviolet curable liquid composition comprising:
a cationically polymerizable liquid monomer;
a photopolymerization initiator; and
a photopolymerization sensitizer; and
an electrophoretic fine particle insoluble in the cationically polymerizable liquid monomer,
wherein the cationically polymerizable liquid monomer is a vinyl ether compound,
wherein the photopolymerization initiator comprises a compound represented by general formula (1), and
wherein the photopolymerization sensitizer comprises:
(A) at least one compound selected from the group consisting of a compound represented by general formula (2) and a compound represented by general formula (3), and
(B) at least one compound selected from the group consisting of a compound represented by general formula (4) and a compound represented by general formula (5): 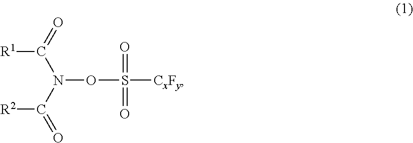
wherein, in the general formula (1), x represents an integer of 1 to 8, y represents an integer of 3 to 17, and R¹ and R² are bound to each other to form a cyclic structure: 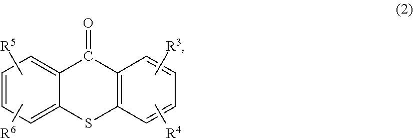
wherein, in the general formula (2), R³, R⁴, R⁵ and R⁶ each independently represents a hydrogen atom, a substituted or unsubstituted alkyl group, a substituted or unsubstituted cycloalkyl group, a substituted or unsubstituted alkoxy group, a substituted or unsubstituted aryloxy group, a cyano group, a substituted or unsubstituted aralkyl group, a substituted or unsubstituted alkoxycarbonyl group, or a halogen atom; 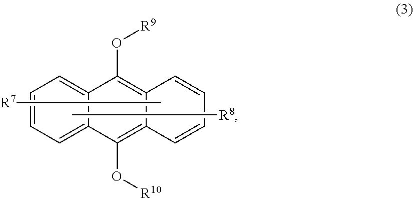
wherein, in the general formula (3), R⁷ and R⁸ each independently represents a hydrogen atom, an alkyl group, an aralkyl group, an alkoxy group, an aryloxy group, or a halogen atom, and R⁹ and R¹⁰ each independently represents a hydrogen atom, an aralkyl group, an alkyl group having 1 to 9 carbon atoms optionally substituted with a group having an oxygen atom, or a glycidyl group; 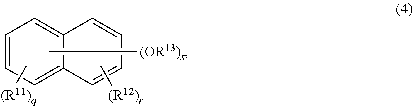
wherein, in the general formula (4), R¹¹ and R¹² each independently represents an alkyl group, an aralkyl group, an alkoxy group, an aryloxy group, or a halogen atom, q and r each independently represent an integer of 0 to 4, R¹³ represents a hydrogen atom, an alkyl group having 1 to 9 carbon atoms optionally substituted with a substituent having an oxygen atom, a glycidyl group, or an aralkyl group, s represents an integer of 1 to 3, each R¹¹ is independently selected when more than one R¹¹ is present, each R¹² is independently selected when more than one R¹² is present, and each R¹³ is independently selected when more than one R¹³ is present and 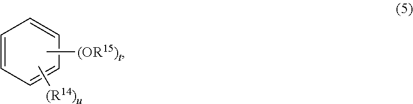
wherein, in the general formula (5), R¹⁴ represents an alkyl group, an aralkyl group, an alkoxy group, an aryloxy group or a halogen atom, u represents an integer of 0 to 4, R¹⁵ represents a hydrogen atom, an alkyl group having 1 to 9 carbon atoms optionally substituted with a substituent having an oxygen atom, a glycidyl group, or an aralkyl group, t represents an integer of 1 or 2, each R¹⁴ is independently selected when more than one R¹⁴ is present, and each R¹⁵ is independently selected when more than one R¹⁵ is present.
